(19) United States
(12) Patent Application Publication
(10) Pub. No.: US 2019/0384537 A1
(43) Pub. Date: Dec. 19, 2019

(54) IMAGE FORMING SYSTEM

(71) Applicant: Oki Data Corporation, Tokyo (JP)

(72) Inventors: Taiki ARAI, Tokyo (JP); Hirohito OKAZAKI, Tokyo (JP)

(21) Appl. No.: 16/389,395

(22) Filed: Apr. 19, 2019

(30) Foreign Application Priority Data
Jun. 19, 2018 (JP) 2018-116402

(51) Int. Cl. G06F 3/12; H04W 4/06

(52) U.S. Cl. CPC G06F 3/1204; H04W 4/06; G06F 3/126; G06F 3/1269; H04W 84/12; G06F 3/1238; G06F 3/1222; G06F 3/1236; G06F 3/1292; G06F 3/1231

(57) ABSTRACT

An image forming system has an image forming apparatus, a terminal device and a network. The terminal device is provided with a broadcast packet sending part that sends a broadcast packet, the image forming apparatus is provided with a response sending part that sends image forming apparatus specifying information specifying itself in the network as a response to the broadcast packet, and an image forming part that forms an image. The response receiving part receives the response from the image forming apparatus, an apparatus specifying part specifies the image forming apparatus that sent the response based on the image forming apparatus specifying information contained in the response, a print job sending part that sends a print job to the image forming apparatus through the network based on the image forming apparatus specifying information, and the image forming part of the image forming apparatus forms the image on a medium according to the print job received from the terminal device.

### TECHNICAL FIELD

This invention relates to an image forming system that is preferable in applying to a case where a print job is sent to be printed by an image forming apparatus connected through a network from a terminal device such as a smartphone.

### BACKGROUND

In recent years, commonly used is an image forming system where an image forming device is connected with a terminal device such as a computer device through a network, and the image forming device receives a print job from the terminal device through the network and forms, that is, prints, an image based on the print job on a medium such as a sheet.

Proposed as such an image forming system is the one utilizing a wireless LAN (Local Area Network) as the network (see Patent Document 1 for example). In such an image forming system as this, various terminal devices such as a notebook-type computer device, a tablet-type terminal device, or a smartphone having a wireless LAN function built-in can be connected to the network.

### RELATED ART

[Patent Doc. 1] Japanese Laid-Open Patent Application Publication 2016-101676 (FIG. 2 and others.)

By the way, newly connecting a terminal device to a wireless LAN in general requires properly setting an SSID (Service Set Identifier) and a password of the wireless LAN and assigning it with an IP address.

However, when a general user performs such work, it is laborious because of his inexperience, and also the SSID, the password, the IP address, etc. need to be acquired from an administrator or the like. Especially, there was a problem that even when the user wished to use an image forming apparatus temporarily, work related to the network connection was extremely complex, preventing an easy use.

This invention was made considering the above points and attempts to propose an image forming system that allows an easy print process from a terminal device.

### SUMMARY

An image forming system, which is disclosed in the application, has an image forming apparatus, a terminal device, and a network that connects the image forming apparatus and the terminal device. The terminal device is provided with a broadcast packet sending part that sends a broadcast packet, which is associated with a broadcast format, through the network, the image forming apparatus is provided with a response sending part that sends, through the network, image forming apparatus specifying information that specifies itself in the network as a response to the broadcast packet, and an image forming part that forms an image, the terminal device is further provided with a response receiving part that receives the response from the image forming apparatus that received the broadcast packet, an apparatus specifying part that receives the response, and specifies the image forming apparatus that sent the response based on the image forming apparatus specifying information contained in the response wherein the image forming apparatus is a specified image forming apparatus, and a print job sending part that sends a print job to the specified image forming apparatus through the network based on the image forming apparatus specifying information contained in the response, which is specified by the apparatus specifying part, and the image forming part of the specified image forming apparatus forms the image on a medium according to the print job received from the terminal device.

According to one of the embodiments of the invention, the terminal device is able to obtain an image forming apparatus specifying information in the network by selecting the response sent from the specified image forming apparatus based on the responses sent from image forming apparatuses in correspondence with the broadcast sent from the terminal device. Using that, the terminal device has the specified image forming apparatus execute a print process by sending the print job to the specified image forming apparatus.

This invention allows realizing an image forming system where a print process can be easily performed from a terminal device.

### BRIEF DESCRIPTION OF THE DRAWINGS

FIG. 1 is a schematic diagram showing the overall configuration of an image forming system by the first embodiment.

FIG. 2 is a schematic diagram showing the hardware configuration of an image forming apparatus.

FIG. 3 is a schematic diagram showing the software configuration of the image forming apparatus.

FIG. 4 is a schematic diagram showing the memory content of a wireless LAN setting memory part in the image forming apparatus.

FIG. 5 is a schematic diagram showing the memory content of an authentication information memory part in the image forming apparatus.

FIG. 6 is a schematic diagram showing the memory content of an apparatus information memory part in the image forming apparatus.

FIG. 7 is a schematic diagram showing the memory content of an NFC memory part in the image forming apparatus.

FIG. 8 is a schematic diagram showing the hardware configuration of a terminal device.

FIG. 9 is a schematic diagram showing the software configuration of the terminal device.

FIG. 10 is a schematic diagram showing the memory content of a wireless LAN setting memory part in the terminal device.

FIG. 11 is a schematic diagram showing the memory content of an NFC setting memory part in the terminal device.

FIG. 12 is a schematic diagram showing the memory content of an NFC memory part in the terminal device.

FIG. 13 is a schematic diagram showing the memory content of an apparatus information memory part in the terminal device.

FIG. 14 is a flow chart showing a startup-time information write process procedure in the image forming apparatus.

FIG. 15 is a flow chart showing an apparatus information update process procedure in the image forming apparatus.

FIG. 16 is a flow chart showing an apparatus information modification-time information write process procedure in the image forming apparatus.

FIG. 17 is a flow chart showing an apparatus information acquisition preparation process procedure in the terminal device.

FIGS. 18A-18C are schematic diagrams showing a display screen (1) of the terminal device.

FIGS. 19A-19C are schematic diagrams showing a display screen (2) of the terminal device.

FIG. 20 is a flow chart showing a wireless LAN connection process procedure by the terminal device.

FIGS. 21A-21C are schematic diagrams showing a display screen (3) of the terminal device.

FIG. 22 is a flow chart showing a wireless LAN connection process procedure in the image forming apparatus.

FIG. 23 is a schematic diagram showing a display screen (4) of the terminal device.

FIG. 24 is a flow chart showing a print job sending process procedure in the terminal device.

FIGS. 25A-25C are schematic diagrams showing a display screen (5) of the terminal device.

FIG. 26 is a flow chart showing a registered apparatus print process procedure in the terminal device.

FIG. 27 is a schematic diagram showing the overall configuration of an image forming system by the second embodiment.

FIG. 28 is a schematic diagram showing a print history table of an image forming apparatus.

FIG. 29 is a schematic diagram showing a print history table of a terminal device.

FIG. 30 is a sequence chart showing a new print process procedure by the second embodiment.

FIGS. 31A-31B are schematic diagrams showing a display screen (6) of the terminal device.

FIG. 32 is a sequence chart showing a reprint process procedure by the second embodiment.

FIG. 33 is a schematic diagram showing a display screen (7) of the terminal device.

FIG. 34 is a schematic diagram showing the configuration of an image forming system by another embodiment.

### DETAILED DESCRIPTION OF PREFERRED EMBODIMENTS

Below, embodiments of this invention are explained referring to drawings.

### 1. First Embodiment

### 1-1. Configuration of Image Forming System

As shown in FIG. 1, an image forming system 1 by the first embodiment is configured so that an image forming apparatus 2 and a terminal device 3 are mutually connected through a wireless LAN 7 as a network and can mutually send and receive information through NFC (Near Field Communication) 8.

### 1-2. Configuration of Image Forming Apparatus

The image forming apparatus 2 is so-called an MFP (Multi-Function Peripheral) that has an image scanner function to read an image and a communication function as well as a printer function to form (that is, print) an image on a sheet as a medium, and can operate as a printer, a copier, or a facsimile machine by combining them.

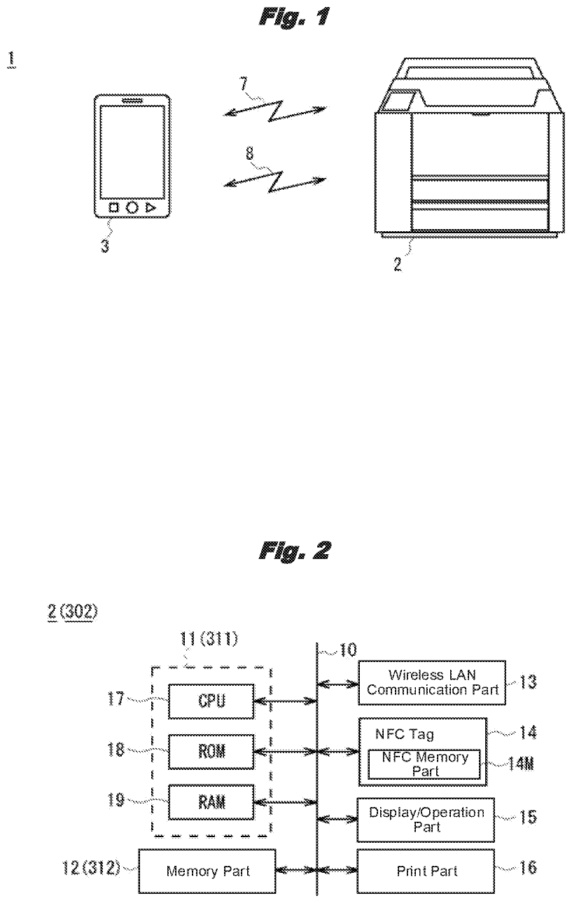

As its block configuration is shown in FIG. 2, this image forming apparatus 2 has a control part 11, a memory part 12, a wireless LAN communication part 13, an NFC tag 14, a display/operation part 15, and a print part 16 mutually connected through a bus 10.

The control part 11 is configured centering on a CPU (Central Processing Unit) 17 and executes various processes such as a print process and an information communication process by reading prescribed programs from ROM (Read Only Memory) 18 or the memory part 12 and using RAM (Random Access Memory) 19 as a work area. The memory part 12 is a nonvolatile information memory medium such as a hard disk drive or flash memory and stores various programs, various setting information, various data, etc. Also, the memory part 12 stores setting values consisting of values preset by users, values set at the factory shipment time, etc., an IP address in the wireless LAN 7 (FIG. 1), print density, a uniquely-assigned manufacturer's serial number, etc.

The wireless LAN communication part 13 is a wireless interface conforming to a standard such as IEEE (Institute of Electrical and Electronics Engineers) 802.11a/b/g/n/ac. This wireless LAN communication part 13 can switch among multiple operation modes such as an infrastructure mode (hereafter also called as an infra mode) and an access point mode (hereafter also called as an AP mode).

Among these, the infra mode is an operation mode where the image forming apparatus 2 becomes so-called a child machine, wirelessly connects to a prescribed base station (an access point or a mother machine, not shown), and sends/receives information with the terminal device 3 etc. through the base station. On the other hand, the access point mode is an operation mode where the image forming apparatus 2 becomes so-called a parent machine, has the terminal device 3 etc. wirelessly connected as child machines, and sends/receives information with the terminal device 3 etc.

The NFC tag 14 is a wireless interface for NFC (Near Field Communication) regulated by an international standard such as ISO/IEC 18092. This NFC tag 14 has an NFC memory part 14M to store information as well as an antenna to perform wireless communication and a circuit to perform various signal processing (not shown) etc. This NFC memory part 14M can store various information in advance by the control of the control part 11. Also, written in the vicinity of the NFC tag 14 on the outer surface of the image forming apparatus 2 is a prescribed mark indicating that the antenna of the NFC tag 14 is installed.

When the terminal device 3 is held over by the user, that is, when the terminal device 3 is moved to a position adjacent to the antenna of the NFC tag 14 in the image forming apparatus 2, the NFC tag 14 performs a communication process by NFC 8 with the terminal device 3. At this time the NFC tag 14 can send information stored in advance in the NFC memory part 14M to the terminal device 3, and can also receive information sent from the terminal device 3 to have it stored in the NFC memory part 14M.

The display/operation part 15 is configured of a touch panel where a liquid-crystal panel and a touch sensor are integrated for example. Based on the control of the control part 11, this display/operation part 15 presents various information to the user by displaying various display screens, and can also accept the user's operations input by displaying prescribed GUI (Graphical User Interface) screens.

The print part 16 as an image forming part has exposure devices, a fuser device, a sheet carrying mechanism, etc. that are not shown. Among them, the exposure device has an LED (Light Emitting Diode) head, a photosensitive drum, a toner cartridge, etc., lets the LED head emit light based on image data supplied from the control part 11, thereby forming an electrostatic latent image on the surface of the photosensitive drum, and lets toner adhere to this, thereby forming a toner image. The print part 16 has four exposure devices corresponding to four colors of cyan (C), magenta (M), yellow (Y), and black (K), and can form a color image on a sheet by forming toner images of the individual colors and having them transferred and fused to the sheet, that is, perform color printing.

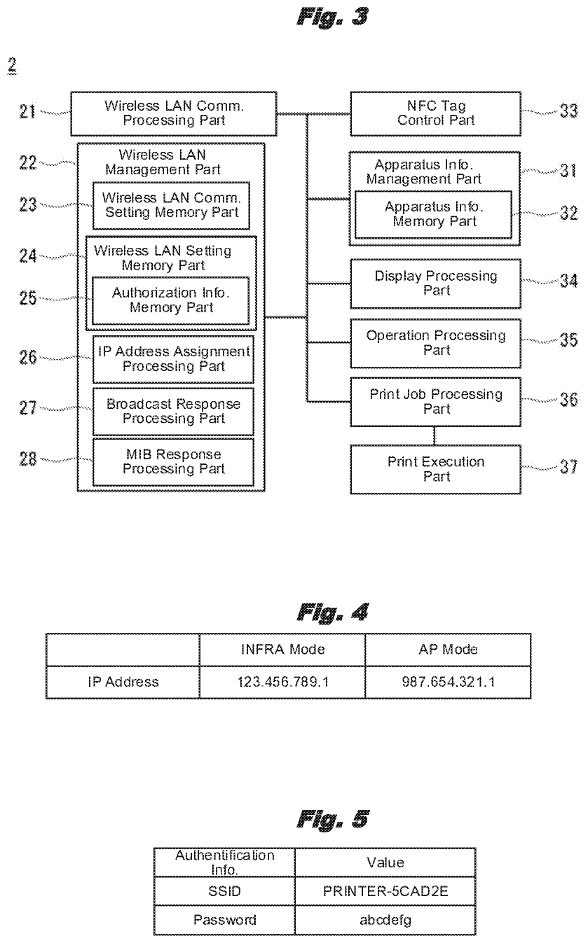

Also, the control part 11 reads prescribed image forming programs from the memory part 12 and executes them, thereby forming multiple functional blocks as shown in FIG. 3 and executing various processes. Incidentally, among the functional blocks shown in FIG. 3, some of those having a function to store information realize the function by utilizing the memory part 12.

A wireless LAN communication processing part 21 performs communication processes in the wireless LAN communication part 13 (FIG. 2), such as modulation/demodulation and packetizing/depacketizing. A wireless LAN management part 22 performs various processes accompanying wireless LAN communication, such as switching the operation modes, an authentication process, and an IP address assignment. This wireless LAN management part 22 further has multiple functional blocks.

A wireless LAN setting memory part 23 stores various information necessary for the wireless LAN operation, such as the operation mode such as the infra mode or the AP mode, and an encryption scheme. Also, as shown in FIG. 4, the wireless LAN setting memory part 23 stores IP addresses for the individual operation modes as an IP address memory table. When an authentication execution part 24 (FIG. 3) is operating in the AP mode, if an external device such as the terminal device 3 requests participation in the network, it performs an authentication process to judge whether to approve the participation. As shown in FIG. 5, an authorization information memory part 25 stores an SSID and a password as authentication information for collation in the authentication process. Stored as these SSID and password are values set in advance by the user or values stored as the initial values at the factory shipment time.

Mainly when operating in the AP mode, an IP address assignment processing part 26 (FIG. 3) assigns an IP address when allowing an external device such as the terminal device 3 to participate in the network. Assigned as this IP address is a value that does not overlap with those of other terminals inside the network within a prescribed value range. A broadcast response processing part 27 as a response sending part performs a response process to send prescribed response information when information by a broadcast has been received. When a command by SNMP (Simple Network Management Protocol) has been received from an external device, an MIB (Management Information Base) response processing part 28 performs a response process for it.

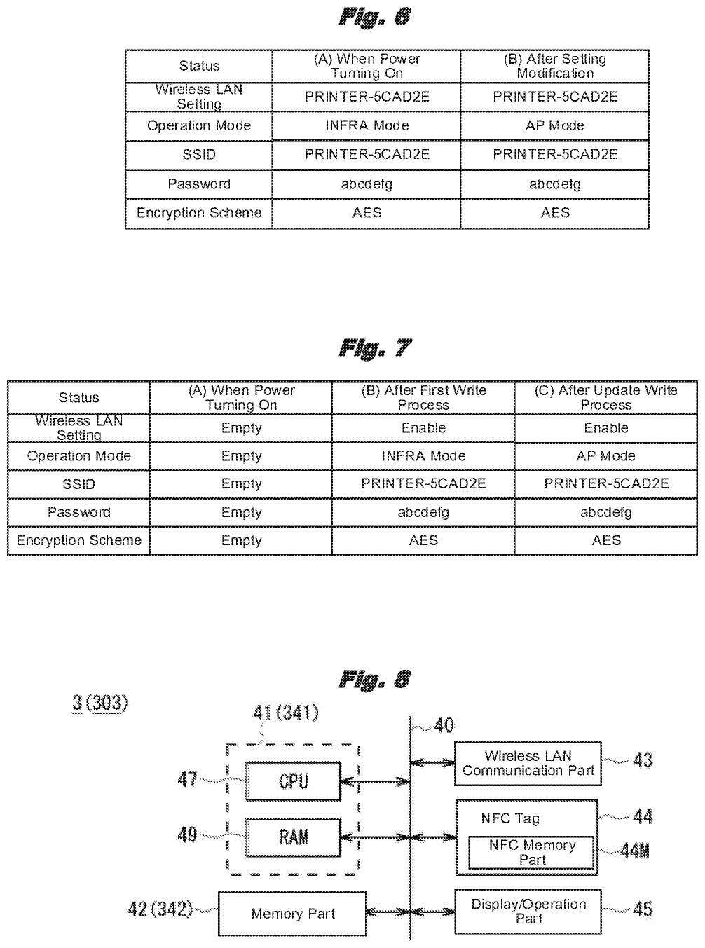

An apparatus information management part 31 collects various pieces of information on the wireless LAN in the image forming apparatus 2 such as the operation mode and the SSID, stores them in the apparatus information memory part 32, and manages them. As shown in FIG. 6, the apparatus information memory part 32 stores information on the wireless LAN collected by the apparatus information management part 31.

An NFC tag control part 33 (FIG. 3) controls the NFC tag 14 (FIG. 2) to read a content (FIG. 6) stored in the apparatus information memory part 32 and write it to the NFC memory part 14M (FIG. 2) or read information from the NFC memory part 14M. Once the apparatus information is written by the NFC tag control part 33, the NFC memory part 14M stores it as shown in FIG. 7.

For example, the NFC memory part 14M stores no information as shown in Column (A) of FIG. 7 when power is turned on. However, once the first write process is performed by the NFC tag control part 33, the NFC memory part 14M stores and retains the same information as the content (FIG. 6) stored in the apparatus information memory part 32 as shown in Column (B) of FIG. 7.

A display processing part 34 (FIG. 3) performs processes related to displaying information such as generating a display screen to be displayed on the display/operation part 15 (FIG. 2). An operation processing part 35 detects an input operation to the display/operation part 15. For example, the display processing part 34 displays a setting modification screen for modifying various setting values in the image forming apparatus 2, that is, the apparatus information. Upon accepting an input operation to this setting modification screen, the operation processing part 35 hands the inputted values over to the apparatus information management part 31. In response to this, the apparatus information management part 31 modifies the apparatus information stored in the apparatus information memory part 32 and stores new information after the modification.

A print job processing part 36 performs a prescribed analysis process etc. on a print job received from the terminal device 3 etc. through the wireless LAN 7, thereby generating print data to be supplied to the print part 16, and hands it over to a print execution part 37. In response to this, the print execution part 37 supplies the received print data to the print part 16 (FIG. 2), thereby performing a print process of forming toner images based on the print data, transferring them to a sheet, and further fusing them.

### 1-3. Configuration of Terminal Device

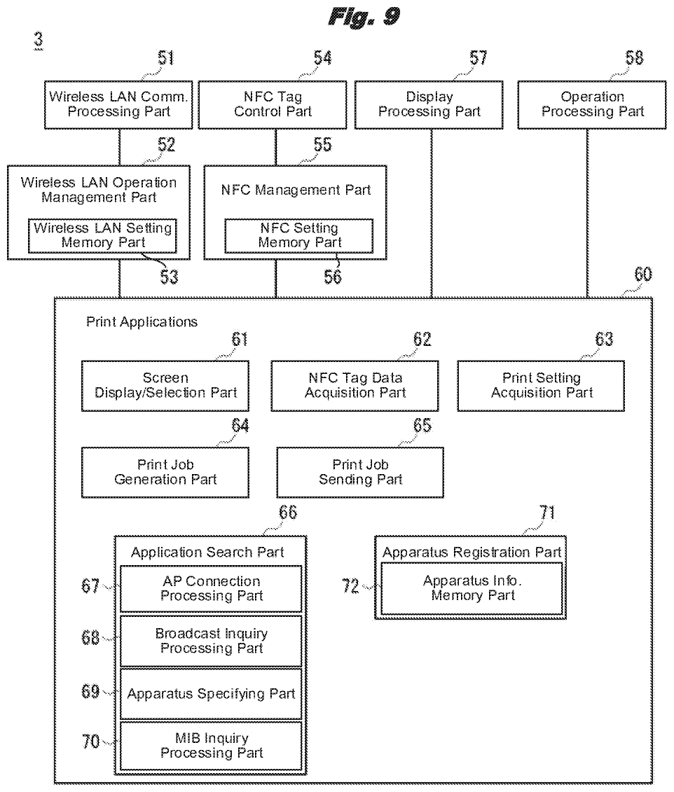

The terminal device 3 (FIG. 1) is so-called a smartphone that has various information processing functions, communication functions, etc., is configured in a relatively compact size, and is carried by the user. As its block configuration is shown in FIG. 8, this terminal device 3 has a control part 41, a memory part 42, a wireless LAN communication part 43, an NFC tag 44, and a display/operation part 45 mutually connected through a bus 40.

The control part 41 is configured centering on a CPU 47 in the same manner as the control part 11 of the image forming apparatus 2, and executes various processes such as an information communication process by reading prescribed programs from the memory part 42 and using RAM 49 as a work area. The memory part 42 is a nonvolatile information memory medium such as flash memory and stores various data such as photos (image data) and document files as well as various programs and various setting information.

The wireless LAN communication part 43 is a wireless interface conforming to a standard such as IEEE 802.11a/b/g/n/ac in the same manner as the wireless LAN communication part 13 of the image forming apparatus 2. This wireless LAN communication part 43 operates in the above-mentioned infra mode, wirelessly connecting as a child machine to an external access point to send/receive various information.

The NFC tag 44 as a near field communication sending part and a near field communication receiving part is configured in the same manner as the NFC tag 14 of the image forming apparatus 2, and has an NFC memory part 44M to store information, as well as an antenna to perform wireless communication, a circuit to perform various signal processing (not shown), etc. This NFC memory part 44M wirelessly connects with the image forming apparatus 2 through NFC 8 (FIG. 1) for example, and upon receiving various information on the wireless LAN from the image forming apparatus 2, stores the information.

The display/operation part 45 as a display part and an operation part is configured as a touch panel in the same manner as the display/operation part 15 of the image forming apparatus 2, and it accepts the user's operation input as well as displays various information.

Also, the control part 41 reads prescribed basic programs from the memory part 42 and executes them, thereby forming multiple functional blocks as shown in FIG. 9 and executing various processes.

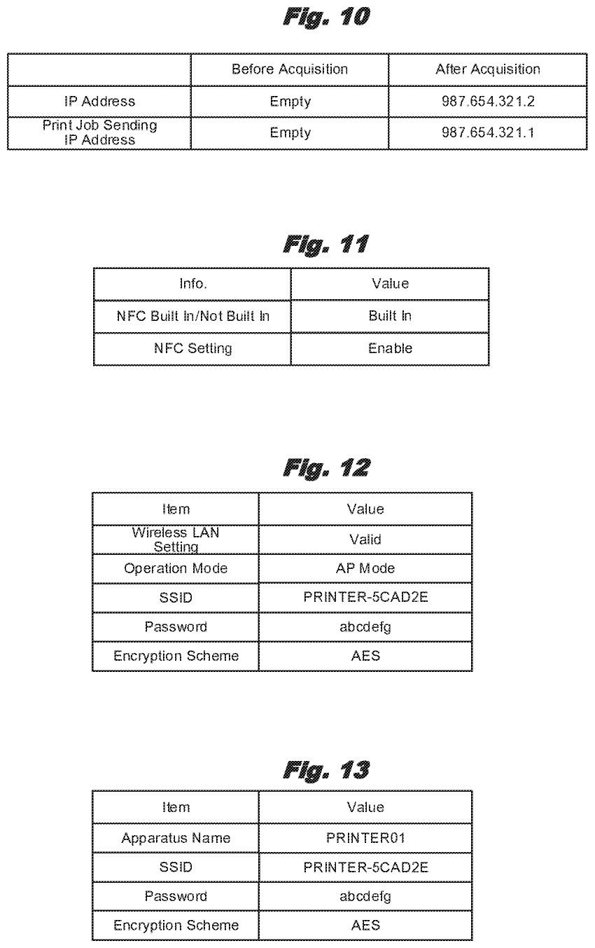

A wireless LAN communication processing part 51 performs various communication processes in the wireless LAN communication part 43 (FIG. 8) in the same manner as the wireless LAN communication processing part 21 (FIG. 3) of the image forming apparatus 2. A wireless LAN operation management part 52 manages various setting values etc. in the wireless LAN communication part 43, and stores these values in the wireless LAN setting memory part 53. As shown in FIG. 10 for example, the wireless LAN setting memory part 53 stores the IP address assigned to the terminal device 3, a print job sending IP address for sending a print job, etc.

An NFC tag control part 54 (FIG. 9) controls the NFC tag 44 (FIG. 8) to read information from the NFC memory part 44M (FIG. 8) in the same manner as the NFC tag control part 33 (FIG. 3) of the image forming apparatus 2. An NFC management part 55 manages information on the NFC tag 44 such as whether the NFC tag 44 is built in the terminal device 3 and whether the operation of the NFC tag 44 is valid or invalid, and stores the content in an NFC setting memory part 56. The NFC setting memory part 56 stores various information on the setting of the NFC tag 44 in a management table shown in FIG. 11.

A display processing part 57 (FIG. 9) performs processes related to displaying information such as generating a display screen to be displayed on the display/operation part 45. An operation processing part 58 detects an input operation performed to the display/operation part 45 by the user, and hands the inputted content over to the individual functional blocks.

Furthermore, the control part 41 reads prescribed programs from the memory part 42 and executes them, thereby forming a print application 60 as a functional block. This print application 60 is an application for sending a print job from the terminal device 3 to the image forming apparatus 2 and having it execute a print process, and has multiple functional blocks inside.

A screen display/selection part 61 determines the content of a display screen to be displayed on the display/operation part 45, and also accepts a selection operation to the display screen. As shown in FIG. 12 for example, an NFC tag data acquisition part 62 receives information that was acquired by the NFC tag 44 (FIG. 8) and is stored in the NFC memory part 44M, and analyzes it. A print setting acquisition part 63 acquires a print setting instructed by the user through a prescribed print setting screen. A print job generation part 64 generates a print job based on an image, a document, or the like that the user instructed to print. A print job sending part 65 performs a process for sending the print job generated by the print job generation part 64 to the image forming apparatus 2 through the wireless LAN 7 (FIG. 1).

An apparatus search part 66 controls the wireless LAN communication part 43 (FIG. 8) to search for other apparatuses connected to the wireless LAN 7 (FIG. 1). The apparatus search part 66 further has multiple functional blocks inside. An access point connection processing part 67 connects to an access point of the wireless LAN 7 (FIG. 1) and requests an IP address assignment to the terminal device 3. A broadcast inquiry processing part 68 as a broadcast sending part and a response receiving part connects to an access point, and afterwards generates and sends a broadcast packet, thereby searching for other apparatuses connected to the wireless LAN 7.

An apparatus specifying part 69 specifies, among responses to the broadcast, the one received from the image forming apparatus 2 (the details are mentioned below). An MIB inquiry processing part 70 generates and sends an MIB command to the image forming apparatus 2 connected to the wireless LAN 7, thereby inquiring whether the image forming apparatus 2 is in a printable state, that is, on line.

An apparatus registration part 71 registers information on the image forming apparatus 2 searched for by the apparatus search part 66 in the print application 60, thereby storing the information on the image forming apparatus 2 in an apparatus information memory part 72. As shown in FIG. 13, this apparatus information memory part 72 stores information such as the apparatus name and the SSID of the image forming apparatus 2 as information necessary for connecting with the image forming apparatus 2 through the wireless LAN 7. Thereby, the print application 60 can perform a search process using the stored SSID for printing next time and thereafter, making it possible to connect easily with the registered image forming apparatus 2 and instruct printing (the details are mentioned below).

### 1-4. Wireless Connection Print Process

Next, explained is a wireless connection print process where a print process is performed by connecting the terminal device 3 to the image forming apparatus 2 through the wireless LAN 7. Here, it is assumed that the image forming apparatus 2 is set to the infra mode and connected to another network that is not shown. It is also assumed that the terminal device 3 is not connected with the image forming apparatus 2 through the wireless LAN and has not acquired information on the wireless LAN for connecting to the image forming apparatus 2, either. It is further assumed that the user carrying the terminal device 3 is located in the vicinity of the image forming apparatus 2 and wishes a print process of a photo (that is, image data) by the image forming apparatus 2. For the convenience of explanation, this image forming apparatus 2 is also called the target apparatus.

In this image forming system 1, it is explained in the user's manual etc. that an operation called “print by holding over” using the terminal device 3 should be performed in performing a print process using the image forming apparatus 2 from the terminal device 3 that is not connected to the image forming apparatus 2 through the wireless LAN. In this “print by holding over”, first the operation mode of the wireless LAN in the image forming apparatus 2 is changed to the AP mode, next the print application 60 (FIG. 9) is started in the terminal device 3, and the terminal device 3 is placed adjacent to the NFC tag 14 of the image forming apparatus 2 to have them perform near field communication.

### 1-4-1. Preparation by Image Forming Apparatus

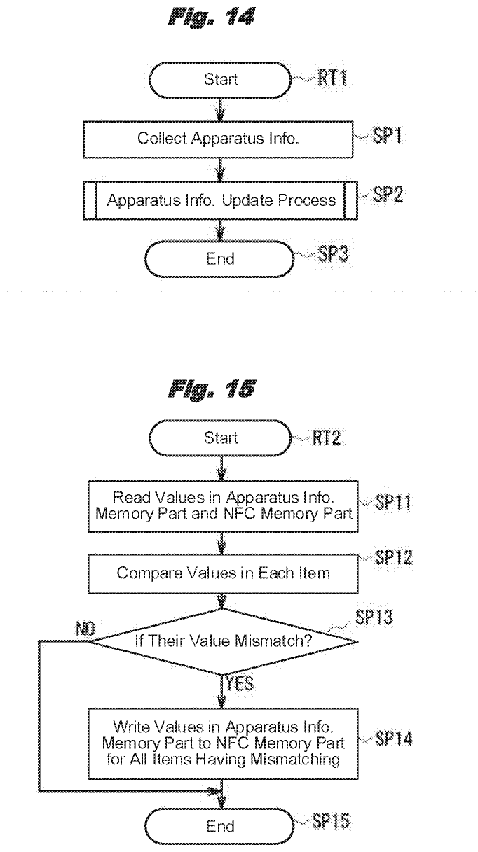

First, explained is a preparation in the image forming apparatus 2. Once its power is turned on by the operation of the user, the administrator, or the like, the image forming apparatus 2 performs a startup-time information write process to write information to the NFC memory part 14M (FIG. 2) of the NFC tag 14 as well as initialization processes etc. of the individual parts. Specifically, once the power is turned on, the control part 11 of the image forming apparatus 2 starts a startup-time information write process procedure RT1 shown in FIG. 14 and moves to SP1. Incidentally, once the power is turned on, the image forming apparatus 2 sets the operation mode of the wireless LAN to the infra mode, and further memorizes that its current operation mode is the infra mode in the wireless LAN setting memory part 23 (FIG. 3).

In SP1 the control part 11 collects information on the wireless LAN of the image forming apparatus 2 from the wireless LAN setting memory part 23 etc. and stores it in the apparatus information memory part 32 by the apparatus information management part 31 (FIG. 3), and moves to the next SP2. Thereby, as shown in Column (A) of FIG. 6, the apparatus information when the power is turned on is stored in the apparatus information memory part 32. Incidentally, when the power is turned on, the NFC memory part 14M has values of all the individual items empty as shown in Column (A) of FIG. 7.

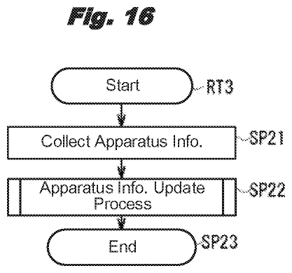

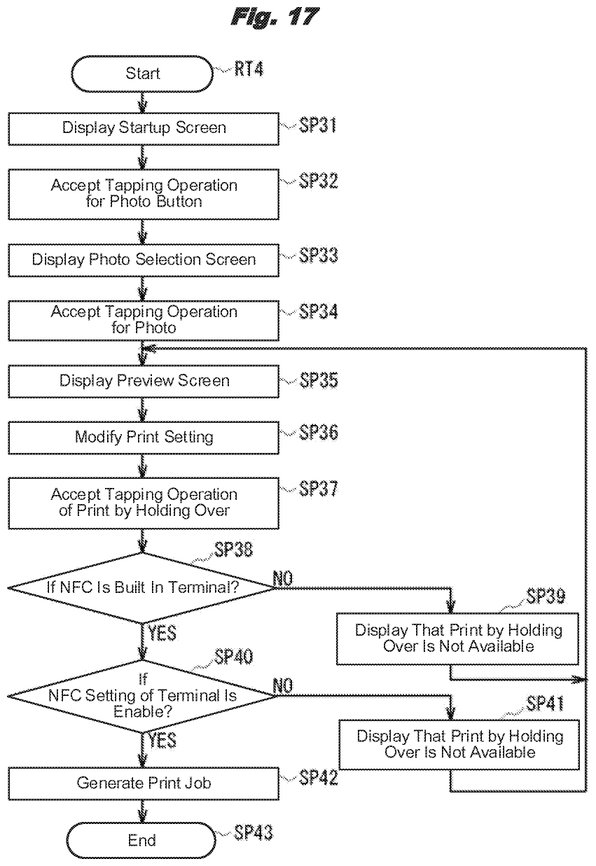

In SP2 the control part 11 executes an apparatus information update process procedure RT2 shown in FIG. 15 as a subroutine, thereby updating the memory content of the NFC memory part 14M. Specifically, upon starting the apparatus information update process procedure RT2, the control part 11 moves to the first SP11, reads values stored in the individual items, that is, individual values listed in Column (A) of FIG. 6 and individual values listed in Column (A) of FIG. 7, from the apparatus information memory part 32 (FIG. 3) and the NFC memory part 14M (FIG. 2), and moves to the next SP12.

In SP12 the control part 11 compares the values read from the apparatus information memory part 32 (FIG. 6) and the values read from the NFC memory part 14M (FIG. 7), and moves to the next SP13.

In SP13 the control part 11 judges whether there is any item whose value read from the apparatus information memory part 32 (FIG. 6) and value read from the NFC memory part 14M (FIG. 7) mismatch. If a positive result is obtained, that is, if their values mismatch for at least one item, the control part 11 moves to the next SP14. Incidentally, when the power is turned on, because all the items of the NFC memory part 14M are empty, the values of all the items mismatch.

In SP14 the control part 11 writes the values in the apparatus information memory part 32 to the NFC memory part 14M for all the items having mismatching values, and moves to the next SP15, ending the apparatus information update process procedure RT2. Thereby, as shown in Column (B) of FIG. 7, the NFC memory part 14M comes into a state where the values of its individual items match with the values of individual items in the apparatus information memory part 32 (Column (A) of FIG. 6).

On the other hand, if a negative result is obtained in SP13, it indicates that the values in the NFC memory part 14M match with the values in the apparatus information memory part 32 for all the items and that there is no need to modify the values in the NFC memory part 14M. At this time the control part 11 moves to the next SP15, ending the apparatus information update process procedure RT2.

After finishing the apparatus information update process procedure RT2, the control part 11 returns to the original startup-time information write process procedure RT1 (FIG. 14), and then moves to the next SP3, ending the startup-time information write process procedure RT1.

Afterwards, in the image forming apparatus 2, a prescribed setting modification operation is performed through the display/operation part 15 (FIG. 2) by the user, the administrator, or the like who wishes a print process from the terminal device 3 (that is, the execution of “print by holding over”), thereby the operation mode of the wireless LAN is switched from the infra mode to the AP mode. At this time, when the apparatus information such as the operation mode of the wireless LAN has been modified, the control part 11 executes an apparatus information modification-time information write process procedure RT3 shown in FIG. 16.

Specifically, once the apparatus information modification-time information write process procedure RT3 is started, the control part 11 moves to the first SP21. In SP21, in the same manner as in SP1 (FIG. 14), the control part 11 collects information on the wireless LAN of the image forming apparatus 2 from the wireless LAN setting memory part 23 etc. and stores it in the apparatus information memory part 32 by the apparatus information management part 31 (FIG. 3), and moves to the next SP22. Thereby, as shown in Column (B) of FIG. 6, the apparatus information after the operation mode is changed is stored in the apparatus information memory part 32. Incidentally, at this time the NFC memory part 14M has values of the individual items written as shown in Column (B) of FIG. 7.

In SP22, in the same manner as in SP2 (FIG. 14), the control part 11 executes the apparatus information update process procedure RT2 (FIG. 15) as a subroutine, thereby updating the memory content of the NFC memory part 14M. In this case, because only the “operation mode” item has a mismatch in SP13, the control part 11 writes only the value of the “operation mode” in SP14. Thereby, as shown in Column (C) of FIG. 7, the memory content of the NFC memory part 14M has the value of the “operation mode” item updated to “AP mode”.

### 1-4-2. Acquisition of Apparatus Information by Terminal Device

Next, explained is a process to acquire apparatus information necessary for connecting with the image forming apparatus 2 through the wireless LAN 7 by the terminal device 3 from the image forming apparatus 2. Once the print application 60 (FIG. 9) is started by the operation of the user, the control part 41 of the terminal device 3 starts an apparatus information acquisition preparation process procedure RT4 shown in FIG. 17, and moves to SP31.

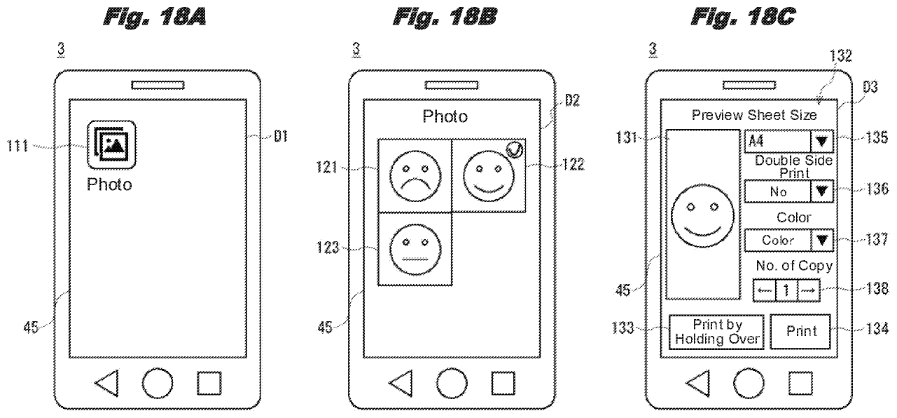

In SP31 the control part 41 displays a startup screen D1 shown in FIG. 18A on the display/operation part 45, and moves to the next SP32. Displayed on this startup screen D1 is a photo category icon 111. This photo category icon 111 indicates that a photo (that is, image data) stored in the memory part 42 (FIG. 8) is selected as the print target.

In SP32, once the control part 41 accepts a tapping operation by the user to the photo category icon 111 (or photo button) on the startup screen D1, it moves to the next SP33. In SP33 the control part 41 displays a photo selection screen D2 shown in FIG. 18B on the display/operation part 45, and moves to the next SP34. Displayed on this photo selection screen D2 are photo icons 121, 122, and 123 as thumbnail images which are shrunk-displayed part of photos (that is, image data) stored in the memory part 42.

In SP34, once the control part 41 accepts a tapping operation to one of photo icons such as the photo icon 122 on the photo selection screen D2, it moves to the next SP35. It indicates that among the multiple photos the user wishes to print the photo (image data) represented as the tapped photo icon by the image forming apparatus 2.

In SP35 the control part 41 displays a preview screen D3 shown in FIG. 18C on the display/operation part 45, and moves to the next SP36. On the preview screen D3, other than a preview image 131 showing the whole image of the photo, a print setting specifying part 132 for letting the user specify a print setting, a print by holding over button 133 for starting the print by holding over process, and a print button 134 for starting a normal print process are installed. Further installed on the print setting specifying part 132 are a sheet size selection column 135 for specifying a sheet size, a double-side print selection column 136 for specifying double-side printing or single-side printing, a color selection column 137 for specifying color printing or monochrome printing, and a number of copies selection column 138 for specifying the number of copies to print.

In SP36, once the user performs an operation to each of the columns of the print setting specifying part 132 on the preview screen D3, the control part 41 modifies the print setting as appropriate according to this operation, and moves to the next SP37. In SP37, once the print by holding over button 133 is tapped, the control part 41 accepts the tapping operation, regards that a print instruction to print the specified photo (hereafter, this is called the target photo) by the image forming apparatus 2 according to the specified print setting has been accepted, and moves to the next SP38. Also, at this time the control part 41 acquires the print setting selection results, the setting values, etc. specified by the user on the preview screen D3 by the print setting acquisition part 63 (FIG. 9).

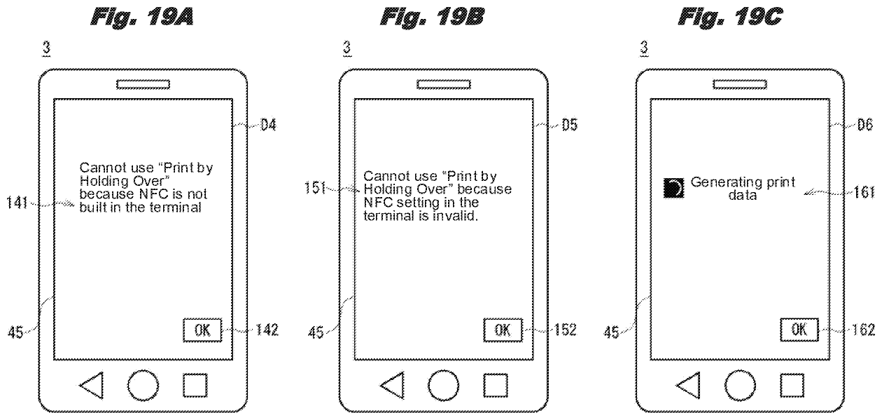

In SP38, by referring to the memory content (FIG. 11) of the NFC setting memory part 56 (FIG. 9), the control part 41 judges whether the NFC tag 44 is built in the terminal device 3. If a negative result is obtained here, it indicates that because the NFC tag 44 is not built in the terminal device 3, the “print by holding over” process cannot be executed. At this time the control part 41 moves to the next SP39, displays an NFC not built-in display screen D4 shown in FIG. 19A on the display/operation part 45, and notifies the user through a message 141 that print by holding over is unavailable. Once an OK button 142 is tapped by the user on this NFC not built-in display screen D4, the control part 41 returns to SP35.

On the other hand, if a positive result is obtained in SP38, it indicates that the terminal device 3 has the NFC tag 14 built in at least. At this time the control part 41 moves to the next SP40, and judges whether the function of the NFC tag 44 is enabled by referring to the memory content (FIG. 11) of the NFC setting memory part 56 (FIG. 9) again. If a negative result is obtained here, it indicates that because the function of the NFC tag 44 is disabled, the “print by holding over” process cannot be executed. At this time the control part 41 moves to the next SP41, displays an NFC disabled display screen D5 shown in FIG. 19B on the display/operation part 45, and notifies the user through a message 151 that the print by holding over is unavailable. Once an OK button 152 is tapped by the user on this NFC disabled display screen D5, the control part 41 returns to SP35.

On the other hand, if a positive result is obtained in SP40, it indicates that because the NFC tag 44 is built in the terminal device 3 and the function of the NFC tag 44 is enabled, the print by holding over process can be executed. At this time the control part 41 moves to the next SP42.

In SP42 the control part 41 starts generating a print job for printing the image data of the target photo according to the specified print setting by the print job generation part 64 (FIG. 9). Along with this, the control part 41 displays a print data creation notification screen D6 shown in FIG. 19C on the display/operation part 45, thereby notifying the user through a message 161 that the print job (print data) is being generated. After doing so, the control part 41 moves to the next SP43, ending the apparatus information acquisition preparation process procedure RT4.

### 1-4-3. Connection to Wireless LAN

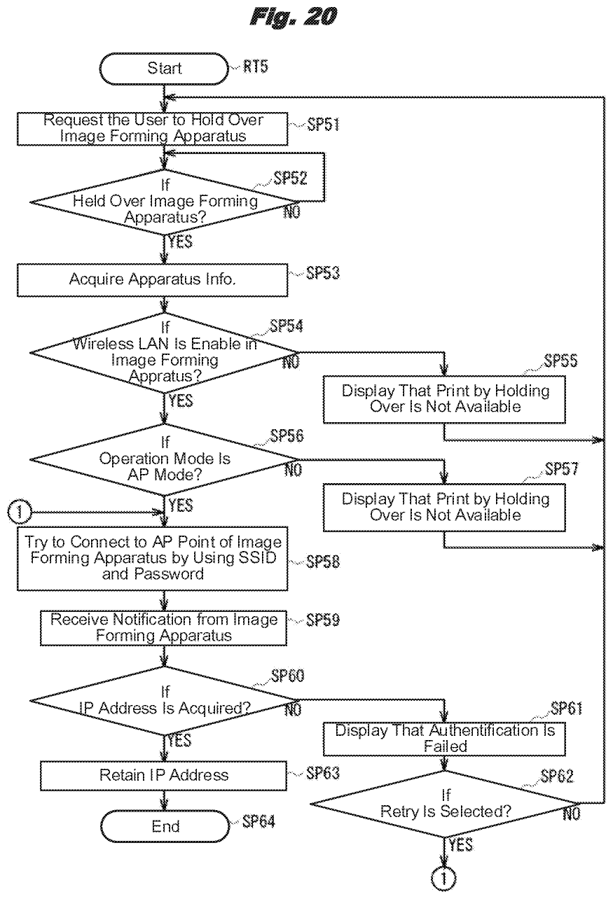

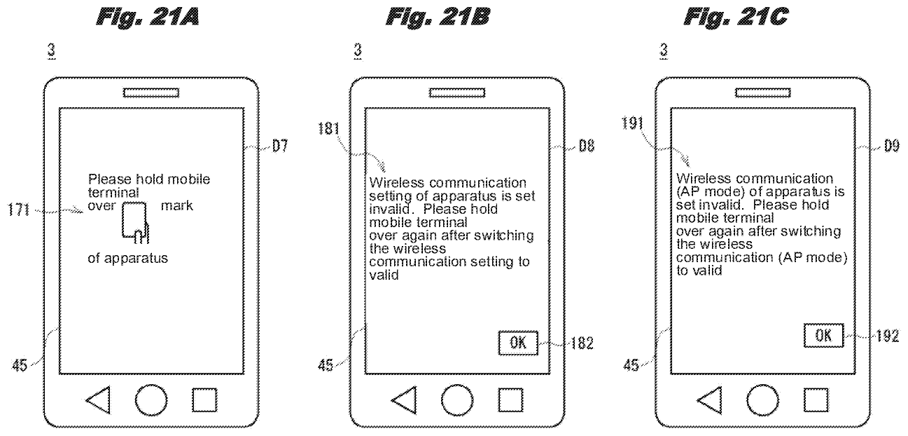

Upon finishing the apparatus information acquisition preparation process procedure RT4 (FIG. 17) mentioned above, the control part 41 subsequently starts a wireless LAN connection process procedure RT5 shown in FIG. 20, and moves to the first SP51. In SP51 the control part 41 displays a hold-over request screen D7 shown in FIG. 21A on the display/operation part 45, thereby requesting the user through a message 171 to hold the terminal device 3 over the NFC tag 14 of the image forming apparatus 2.

In SP52 the control part 41 judges whether the terminal device 3 was held over the NFC tag 14 of the image forming apparatus 2, specifically whether a wireless connection through NFC 8 (FIG. 1) was established by the NFC tag 44 with the NFC tag 14 of the image forming apparatus 2 and information was exchanged. If a negative result is obtained here, the control part 41 repeats this SP52, thereby waiting for the terminal device 3 to be held over the NFC tag 14 of the image forming apparatus 2.

On the other hand, if a positive result is obtained in SP52, it indicates that the NFC tag 44 established a wireless connection through NFC 8 (FIG. 1) with the NFC tag 14 of the image forming apparatus 2, exchanged information, and stored the apparatus information received from the image forming apparatus 2 in the NFC memory part 44M. That is, as shown in FIG. 12, the same information as the memory content (Column (C) of FIG. 7) stored in the NFC memory part 14M of the image forming apparatus 2 is stored in the NFC memory part 44M. At this time the control part 41 moves to the next SP53, acquires the apparatus information from the NFC memory part 44M by the NFC tag data acquisition part 62 (FIG. 9), and moves to the next SP54. In other words, even if multiple image forming apparatuses exist in the image forming system 1, the image forming apparatus 2 over which the terminal device 3 was held by the user at this time becomes the target apparatus by which the user wishes to execute the print process.

In SP54 the control part 41 refers to the acquired apparatus information and judges whether the wireless LAN function is enabled in the image forming apparatus 2. If a negative result is obtained here, it indicates that information exchange through the wireless LAN 7 (FIG. 1) with the image forming apparatus 2, specifically sending a print job, cannot be performed. At this time the control part 41 moves to the next SP55.

In SP55 the control part 41 displays a notification screen D8 shown in FIG. 21B on the display/operation part 45, notifies through a message 181 that the wireless LAN function in the image forming apparatus 2 is disabled, and requests the user to enable the wireless LAN function by modifying the setting. Afterwards, once an OK button 182 is tapped on this notification screen D8, the control part 41 returns to SP51.

On the other hand, if a positive result is obtained in SP54, the control part 41 moves to the next SP56, refers to the acquired apparatus information again, and judges whether the operation mode of the wireless LAN is the AP mode in the image forming apparatus 2. If a negative result is obtained here, it indicates that because the image forming apparatus 2 is not in the AP mode, a connection through the wireless LAN with the image forming apparatus 2 as the parent machine and the terminal device 3 as the child machine cannot be formed. At this time the control part 41 moves to the next SP57.

In SP57 the control part 41 displays a notification screen D9 shown in FIG. 21C on the display/operation part 45, notifies that the operation mode of the wireless LAN in the image forming apparatus 2 is other than the AP mode, and further requests the user to change the operation mode of the wireless LAN to the AP mode by modifying the setting. Afterwards, once an OK button 192 is tapped on this notification screen D9, the control part 41 returns to SP51.

On the other hand, if a positive result is obtained in SP56, it indicates that because the wireless LAN of the image forming apparatus 2 is enabled and the operation mode is the AP mode, a connection through the wireless LAN 7 (FIG. 1) can be formed with the image forming apparatus 2 as the parent machine and the terminal device 3 as the child machine. At this time the control part 41 moves to the next SP58.

In SP58 the control part 41 sends the SSID and the password of the apparatus information by the access point connection processing part 67 (FIG. 9), thereby trying to connect through the wireless LAN with the image forming apparatus 2 operating in the AP mode, and at the same time requests an IP address assignment to the image forming apparatus 2.

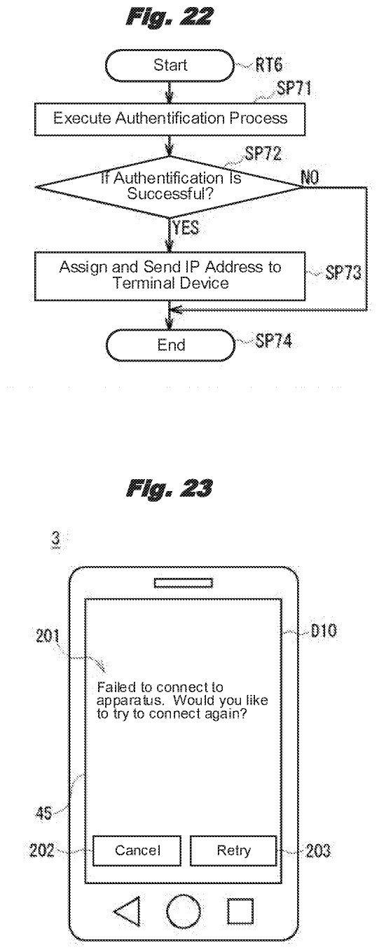

In response to this, the control part 11 of the image forming apparatus 2 starts a wireless LAN connection process procedure RT6 shown in FIG. 22, and moves to the first SP71. In SP71 the control part 11 collates the SSID and the password received from the terminal device 3 with the SSID and the password stored in the authentication information memory part 25 (FIG. 5) as an authentication process by the authentication execution part 24 (FIG. 3), and moves to the next SP72.

In SP72 the control part 11 judges whether the authentication was successful, that is, whether the SSID and the password received from the terminal device 3 matched with the SSID and the password stored in the authentication information memory part 25. If a positive result is obtained here, it indicates that because the terminal device 3 has acquired proper SSID and password, a connection with the terminal device 3 through the wireless LAN 7 (FIG. 1) should be permitted. At this time the control part 11 moves to the next SP73.

In SP73 the control part 11 assigns a new IP address to the terminal device 3 and sends the IP address to the terminal device 3, afterwards moves to the next SP74, ending the wireless LAN connection process procedure RT6.

On the other hand, if a negative result is obtained in SP72, it indicates that because at least one of the SSID and the password sent from the terminal device 3 mismatches with the SSID or the password stored in the authentication information memory part 25, a connection with the terminal device 3 through the wireless LAN 7 (FIG. 1) should not be permitted. At this time the control part 11 does not assign an IP address to the terminal device 3, and moves to the next SP74, ending the wireless LAN connection process procedure RT6.

In response to this, the control part 41 of the terminal device 3 receives an IP address notification from the image forming apparatus 2 in SP59 of the wireless LAN connection process procedure RT5 (FIG. 20), and moves to the next SP60. In SP60 the control part 41 judges whether an IP address was normally acquired from the image forming apparatus 2.

If a negative result is obtained here, it indicates that because the authentication failed for some reason, no IP address was assigned, that is, a print job cannot be sent to the image forming apparatus 2 in such a situation. At this time the control part 41 moves to the next SP61, displays a notification screen D10 shown in FIG. 23 on the display/operation part 45 to notify through a message 201 that a connection with the image forming apparatus 2 failed, inquires of the user whether to try the connection again, and moves to the next SP62.

In SP62 the control part 41 judges whether a retry button 203 on the notification screen D10 has been tapped (or a retry for connection/authentication is selected). If a positive result is obtained here, the control part 41 returns to SP58 and tries to connect with the image forming apparatus 2 through the wireless LAN again. Also, if a negative result is obtained in SP62, the control part 41 returns to SP51 and repeats a series of processes, thereby acquiring again the apparatus information, that is, the SSID and the password, through NFC 8 (FIG. 1) from the image forming apparatus 2.

On the other hand, if a positive result is obtained in SP60, it indicates that an IP address is assigned from the image forming apparatus 2, and this IP address allows connecting to the network of the wireless LAN 7 (FIG. 1). At this time the control part 41 moves to the next SP63. In SP63 the control part 41 writes the assigned IP address to the wireless LAN setting memory part 53 (FIG. 9) and has it retained (FIG. 10), and afterwards moves to the next SP64, ending the wireless LAN connection process procedure RT5.

### 1-4-4. Sending Print Job by Terminal Device

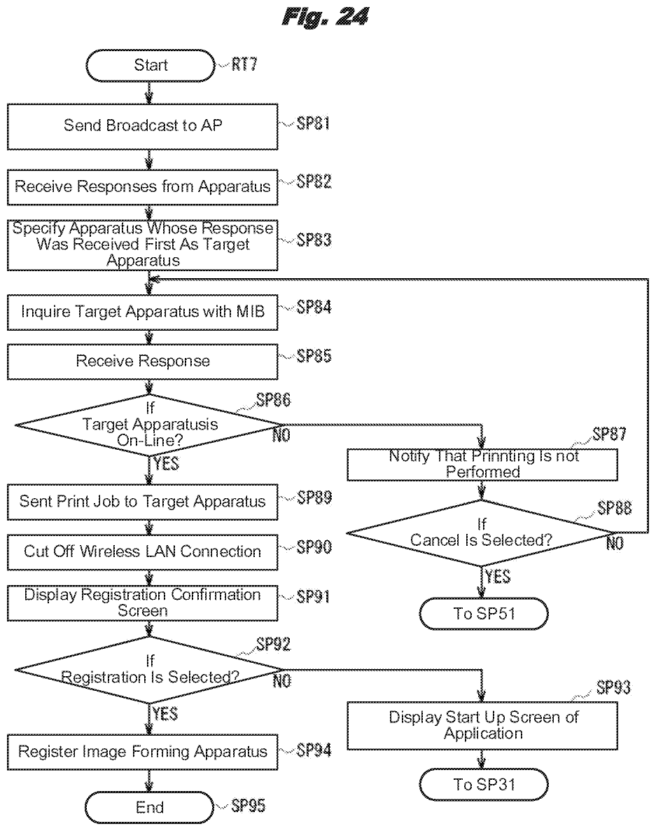

Once finishing the wireless LAN connection process procedure RT5 (FIG. 20) mentioned above, the control part 41 subsequently starts a print job sending process procedure RT7 shown in FIG. 24, and moves to the first SP81. In SP81 the control part 41 sends a broadcast packet to the network of its assigned IP address by the broadcast inquiry processing part 68 (FIG. 9), and moves to the next SP82. Thereby, the control part 41 searches for all apparatuses connected to the same network through the wireless LAN 7 (FIG. 1).

In SP82 the control part 41 receives responses to the broadcast, and moves to the next SP83. At this time, the response from each apparatus contains the IP address of the apparatus that is its origin.

In SP83 the control part 41 specifies by the apparatus specifying part 69 (FIG. 9) the apparatus whose response was received first as the target apparatus by which the user wishes the print process to be executed, and moves to the next SP84. In this embodiment, in the network formed by the wireless LAN 7 (FIG. 1) the terminal device 3 is wirelessly connected with the image forming apparatus 2 as the parent machine. Therefore, the terminal device 3 would first receive the response from the image forming apparatus 2 that is the parent machine. That is, the IP address indicating the origin of the response received first in SP82 becomes the IP address assigned to the image forming apparatus 2 that is the target apparatus. From another point of view, this IP address becomes information for specifying the image forming apparatus 2 in the network formed by the wireless LAN 7 (FIG. 1). Therefore, hereafter the IP address of the image forming apparatus 2 is also called image forming apparatus specifying information.

In SP84 the control part 41 sends an MIB command to the target apparatus (that is, the image forming apparatus 2) by the MIB inquiry processing part 70 (FIG. 9), thereby inquiring whether the target apparatus is on line, and moves to the next SP85. The target apparatus may be referred as a target to send. At this time the MIB inquiry processing part 70 sends an MIB command such as “1.3.6.1.4.1.2001.1.1.1.1.2.30.0”.

In SP85 the control part 41 receives a response to the MIB command from the target apparatus, and moves to the next SP86. In SP86 the control part 41 analyzes the MIB response by the MIB inquiry processing part 70 to judge whether the target apparatus is on line.

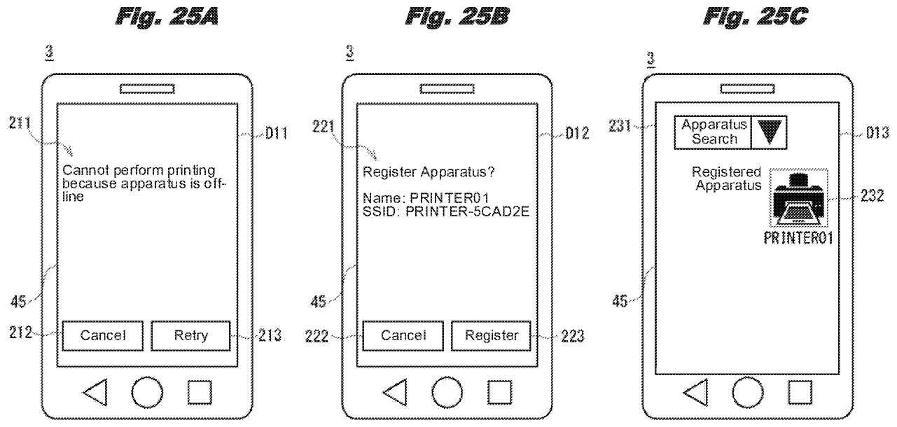

If a negative result is obtained here, the control part 41 moves to the next SP87 to display a notification screen D11 shown in FIG. 25A on the display/operation part 45, notifying through a message 211 that printing cannot be performed because the image forming apparatus 2 is off line, and moves to the next SP88. In SP88 the control part 41 judges whether a cancel button 212 on the notification screen D11 has been tapped. If a negative result is obtained here, it indicates that a retry button 213 on the notification screen D11 has been pressed. At this time, the control part 41 returns to SP84, thereby sending the MIB command again to the target apparatus.

Also, if a positive result is obtained in SP88, it signifies that the user expressed will to cancel printing by the current target apparatus. At this time the control part 41 returns to SP51 of the wireless LAN connection process procedure RT5 (FIG. 20), thereby performing the process again from acquiring the apparatus information by holding the terminal device 3 over the image forming apparatus 2.

On the other hand, if a positive result is obtained in SP86, the control part 41 moves to the next SP89, thereby sending the print job to the image forming apparatus 2 that is the target apparatus through the wireless LAN 7 (FIG. 1) by the print job sending part 65 (FIG. 9), and moves to the next SP90. In response to this, the image forming apparatus 2 receives the print job sent from the terminal device 3, generates print data according to the print setting by the print job processing part 36 (FIG. 3), and supplies it to the print execution part, thereby performing the print process.

In SP90 the control part 41 of the terminal device 3 cuts off the wireless LAN connection, and moves to the next SP91. In SP91 the control part 41 displays a registration confirmation screen D12 shown in FIG. 25B on the display/operation part 45, thereby inquiring of the user whether to register the image forming apparatus 2 through a message 221, and moves to the next SP92. In SP92 the control part 41 judges whether a registration button 223 has been tapped on the registration confirmation screen D12. When the button is tapped, it means that the registration is selected.

If a negative result is obtained here, it indicates that a cancel button 222 has been tapped, the user of the terminal device 3 has no will to perform a print process in future by the image forming apparatus 2 that is the current target apparatus, and has no will to register the image forming apparatus 2. At this time the control part 41 moves to the next SP93. In SP93 the control part 41 moves to SP31 of the apparatus information acquisition preparation process procedure RT4 (FIG. 17), thereby returning to the state immediately after starting up the print application 60. At this step, the staring up screen of the application is displayed. Afterwards, the control part 41 repeats the series of processes according to the user's operation.

On the other hand, if a positive result is obtained in SP92, it indicates that the user of the terminal device 3 has will to perform a print process in future by the image forming apparatus 2 that is the current target apparatus, and also has will to simplify the operation next time and thereafter by registering the image forming apparatus 2 to the print application 60. At this time the control part 41 moves to the next SP94.

In SP94 the control part 41 has the apparatus registration part 71 (FIG. 9) store part of the apparatus information such as SSID, password, and encryption scheme received from the image forming apparatus 2 that is the target apparatus in the apparatus information memory part 72 (FIG. 13), thereby registering the image forming apparatus 2. The control part 41 further displays a registered apparatus display screen D13 shown in FIG. 25C on the display/operation part 45, notifying the user through an icon 232 that the image forming apparatus 2 has been registered, and then moves to the next SP95, ending the print job sending process procedure RT7.

### 1-4-5. Print Process by Registered Image Forming Apparatus

Next, explained is a process when executing a print process by the image forming apparatus 2 from the terminal device 3 in a state where the image forming apparatus 2 is registered as shown in FIG. 25C, that is, when printing for the second time and thereafter by the image forming apparatus 2.

Once the icon 232 is tapped by the user on the registered apparatus display screen D13 (FIG. 25C), the control part 41 of the terminal device 3 starts a registered apparatus print process procedure RT8, and moves to SP101. In this case, because the icon 232 was tapped, the control part 41 comes into a state where the image forming apparatus 2 represented by the icon 232 is selected as the target apparatus. Also, the apparatus information of the image forming apparatus 2 is already stored (FIG. 13) in the apparatus information memory part 72 (FIG. 9).

In SP101, in the same manner as in SP31 of the apparatus information acquisition preparation process procedure RT4 (FIG. 17), the control part 41 displays a startup screen D1 (FIG. 18A) on the display/operation part 45, and moves to the next SP102.

In SP102, in the same manner as in SP32 (FIG. 17), the control part 41 accepts a tapping operation to the photo category icon 111 (or photo button) on the startup screen D1 by the user, and moves to the next SP103. In SP103, after displaying the photo selection screen D2 (FIG. 18B), which includes thumbnails, on the display/operation part 45, the control part 41 lets the user select a photo icon 121 or the like on the photo selection screen D2 in the same manner as in SP34 (FIG. 17), and moves to the next SP104.

In SP104, in the same manner as in SP35 (FIG. 17), the control part 41 displays the preview screen D3 (FIG. 18C) on the display/operation part 45, and moves to the next SP105. In SP105, in the same manner as in SP36 (FIG. 17), the control part 41 lets the user specify a print setting as appropriate, and moves to the next SP106.

In SP106, once the print button 134 on the preview screen D3 (FIG. 18C) is tapped, the control part 41 moves to SP58 of the wireless LAN connection process procedure RT5 (FIG. 20) and sequentially executes the above-mentioned series of processes referring to the apparatus information stored in the apparatus information memory part 72 (FIG. 9).

That is, in comparison with executing the series of processes starting with the apparatus information acquisition preparation process procedure RT4 (FIG. 17), the control part 41 of the terminal device 3 can save the process related to acquiring apparatus information by the registered apparatus print process procedure RT8.

### 1-5. Efficacy, Etc.

In the above configuration of the image forming system 1 by the first embodiment (FIG. 1), when the terminal device 3 that is not connected to the image forming apparatus 2 set to the AP mode is held over, the terminal device 3 is notified through NFC 8 of the apparatus information related to the wireless LAN of the image forming apparatus 2. The terminal device 3 connects to the image forming apparatus 2 through the wireless LAN using the acquired apparatus information, and based on responses obtained by sending a broadcast, specifies the response from the image forming apparatus 2 to acquire its IP address, and sends a print job to have it perform a print process of printing an image on a sheet.

That is, in the image forming system 1, without having the user of the terminal device 3 perform any complicated setting work related to the wireless LAN, only by starting the print application 60 in the terminal device 3 and holding it over the image forming apparatus 2, apparatus information necessary for connecting to the wireless LAN can be acquired. Afterwards, in the image forming system 1, upon establishing a connection through the wireless LAN 7 using the apparatus information acquired by the terminal device 3, the print job is sent to the image forming apparatus 2 to have it execute the print process, therefore again there is no need to have the user perform any operation.

Especially in the image forming system 1, in sending the apparatus information from the image forming apparatus 2 to the terminal device 3 through communication via NFC 8, only the SSID and the password without the IP address of the image forming apparatus 2 itself were contained in the notification (FIG. 7, FIG. 12, etc.) After doing so, in the image forming system 1, based on responses to the broadcast, the IP address of the image forming apparatus 2 is acquired (SP83).

Thereby, in the image forming system 1, the IP address of the image forming apparatus 2 need not be stored in advance as apparatus information, and the most recent IP address can be acquired from the image forming apparatus 2 immediately before sending the print job from the terminal device 3. In other words, in the image forming system 1, even if the IP address of the image forming apparatus 2 is changed, there is no need to update the apparatus information stored in the NFC memory part 14M (FIG. 2) or worry about their mismatch.

From another point of view, in the image forming system 1, because the broadcast mechanism prepared in the wireless LAN 7 is utilized, the terminal device 3 need not separately construct a dedicated mechanism for acquiring the IP address of the image forming apparatus 2.

Also, in the image forming system 1, the wireless LAN of the image forming apparatus 2 is operated in the AP mode, and the terminal device 3 is connected to the network of the wireless LAN having the image forming apparatus 2 as an access point (SP56). Therefore, in the image forming system 1, the possibility that other apparatuses than the image forming apparatus 2 are connected to the same wireless LAN can be suppressed to be extremely low.

Furthermore, in the image forming system 1, even if other apparatuses are connected to the network of the wireless LAN having the image forming apparatus 2 as an access point, when a broadcast is sent from the terminal device 3, the response from the image forming apparatus 2 that is an access point can be received first by the terminal device 3. That is, in the image forming system 1, the terminal device 3 only needs to specify the origin of the first response to the broadcast as the target apparatus, and even if responses from other apparatuses are received, the possibility of mistakenly specifying another apparatus as the target apparatus can be eliminated.

Furthermore, in the image forming system 1, in registering the image forming apparatus 2 to the print application 60, instead of the acquired IP address, the SSID, the password, etc. contained in the apparatus information are registered (SP94). Therefore, in the image forming system 1, even if the IP address of the image forming apparatus 2 is changed after the image forming apparatus 2 was registered to the print application 60 of the terminal device 3, unless the SSID and the password are changed, the terminal device 3 can securely connect to the image forming apparatus 2 through the wireless LAN. In this case, because the terminal device 3 sends a broadcast after connecting to the wireless LAN, based on the response from the image forming apparatus 2, it can acquire the new IP address of the image forming apparatus 2 and securely send a print job to the image forming apparatus 2.

Also in this case, the IP address assigned to the terminal device 3 is not stored but abandoned after sending the print job. Therefore, in the image forming system 1, even if the IP address is assigned to another device after the lease period of the IP address assigned by the image forming apparatus 2, because at the next printing time the terminal device 3 is assigned a new IP address from the image forming apparatus 2, IP address duplication can be securely eliminated.

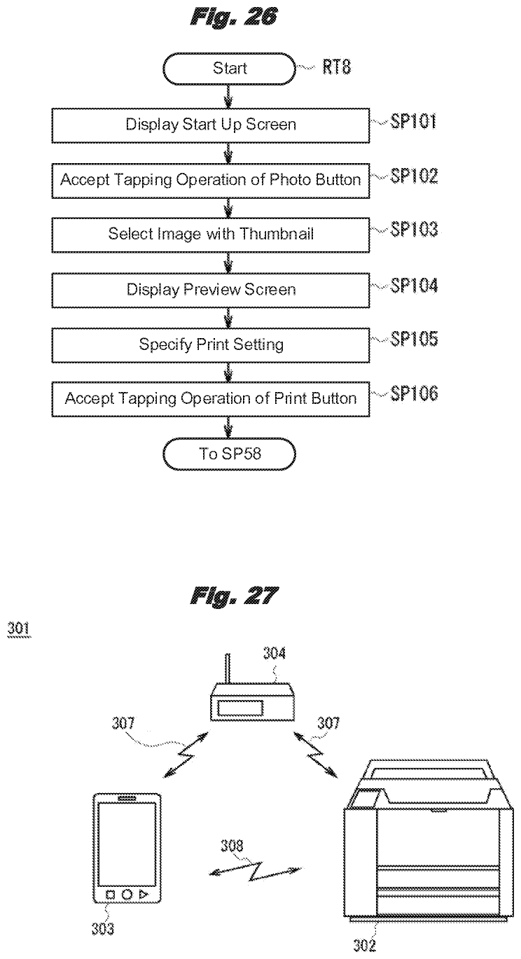

By the way, in a corporation having multiple branches, business offices, or the like, there are cases of constructing the image forming system 1 in each of the branches, business offices, etc., that is, installing the image forming apparatus 2 in each of the branches, business offices, etc. Then, in the image forming systems 1 constructed in the branches, business offices, etc. of this corporation, the SSIDs and the passwords of the image forming apparatuses 2 can be made common, and in any of the branches etc. a terminal device 3 can be held over one of the image forming apparatuses 2 to connect through the wireless LAN, and the image forming apparatus 2 can be registered to the print application 60 of the terminal device 3. Then, in the image forming system 1 of another branch or the like, when the terminal device 3 is brought in, by executing the registered apparatus print process procedure RT8 (FIG. 26) in the terminal device 3, printing can be immediately performed by the image forming apparatus 2 of the branch or the like using the apparatus information registered at another branch or the like.

According to the above configuration, the image forming system 1 by the first embodiment has the terminal device 3 held over the image forming apparatus 2 in the AP mode and acquire the SSID and the password through NFC 8. The terminal device 3 connects to the image forming apparatus 2 through the wireless LAN, based on responses to its broadcast, specifies the image forming apparatus 2 that is the target apparatus and acquires the IP address of the image forming apparatus 2, sends a print job, and has it printed. Thereby, the image forming system 1 can have the image forming apparatus 2 perform printing without having the user of the terminal device 3 perform a complex setting work related to the wireless LAN.

### 2. Second Embodiment

As shown in FIG. 27 that corresponds to FIG. 1, an image forming system 301 by the second embodiment is different from the image forming system 1 by the first embodiment in that an image forming apparatus 302 and a terminal device 303 are each connected to a wireless LAN 307 formed by an access point 304. That is, the image forming apparatus 302 is operating in the infra mode.

### 2-1. Configuration of Image Forming Apparatus and Terminal Device

The image forming apparatus 302 (FIG. 2) and the terminal device 303 (FIG. 8) can mutually send/receive information through this wireless LAN 307. Also, the image forming apparatus 302 and the terminal device 303 can mutually send/receive information also through NFC 308 in the same manner as in the first embodiment.

The image forming apparatus 302 (FIG. 2) has a control part 311 and a memory part 312 substituting for the control part 11 and the memory part 12 in the first embodiment, and also has the same wireless LAN communication part 13, NFC tag 14, display/operation part 15, and print part 16 as in the first embodiment.

The control part 311 internally has a CPU 17 etc. in the same manner as in the first embodiment, and controls individual parts to execute various processes such as a print process by reading prescribed programs from the memory part 312 and executing them. The memory part 312 is a nonvolatile information memory medium such as a hard disk drive in the same manner as the memory part 12 in the first embodiment, and stores various programs, various setting information, etc. Also, the memory part 312 stores print jobs (the details are mentioned below) received from the terminal device 303 in a prescribed file format.

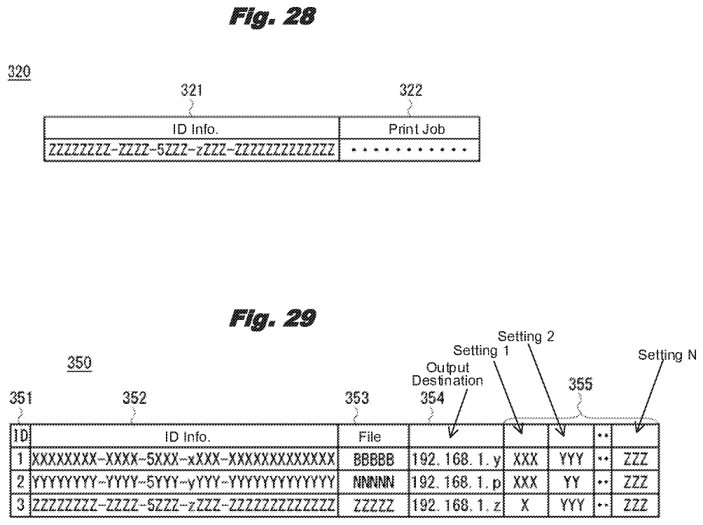

Further installed in the memory part 312 as an image forming apparatus history memory part is a print history table 320 shown in FIG. 28. The print history table 320 is provided with an identification information item (or ID information item) 321 to store identification information (or ID information) mentioned below and a print job item 322 to store the file names of print jobs.

The terminal device 303 (FIG. 8) has a control part 341 and a memory part 342 substituting for the control part 41 and the memory part 42 in the first embodiment, and also has the same wireless LAN communication part 43, NFC tag 44, and display/operation part 45 as in the first embodiment.

The control part 341 internally has a CPU 47 etc. in the same manner as in the first embodiment, and controls individual parts to execute various processes by reading prescribed programs from the memory part 342 and executing them. The memory part 342 is a nonvolatile information memory medium such as flash memory in the same manner as the memory part 42 in the first embodiment, and stores various programs, various setting information, etc. Also, the memory part 342 stores print jobs generated in the past in a prescribed file format.

Further installed in the memory part 342 as a terminal device history memory part is a print history table 350 shown in FIG. 29. The print history table 350 is provided with an ID item 351 to which unique IDs are assigned, an ID information item 352 to store ID information mentioned below, and a file item 353 to store the file names of printed files. The print history table 350 is further provided with an output destination item 354 to store the IP addresses of the image forming apparatuses that executed the print processes, and a print setting item 355 to store the individual print settings.

### 2-2. Wireless Connection Print Process

Next, explained is a wireless connection print process in the image forming system 301 that a print process is performed by sending a print job from the terminal device 303 to the image forming apparatus 302 through the wireless LAN 307.

Here, it is assumed that the image forming apparatus 302 and the terminal device 303 are connected to the access point 304 through the wireless LAN 307 and are each assigned with an IP address. Note that it is assumed that the terminal device 303 has not acquired the IP address of the image forming apparatus 302 and is in a state of being unable to send a print job. Furthermore, the user carrying the terminal device 303 is located in the vicinity of the image forming apparatus 302 and wishes the print process of a photo (that is, image data) by the image forming apparatus 302. For the convenience of explanation, hereafter this image forming apparatus 302 is also called the target apparatus.

In this image forming system 301, it is explained in the user's manual etc. that when a print process is performed using the image forming apparatus 302 from a terminal device 303 that has not acquired the IP address of the image forming apparatus 302, an operation called “print by holding over” using the terminal device 303 should be performed. In this “print by holding over”, after performing a prescribed preparation operation in the terminal device 303, the terminal device 303 is placed adjacent to the NFC tag 14 of the image forming apparatus 302 to have them perform near field communication.

Also, in this embodiment, a process to print a file such as a photo stored in the terminal device 303 by the image forming apparatus 302 for the first time is called a new print process, and a process to print the file by the image forming apparatus 302 for the second time is called a reprint process. Below, the new print process and the reprint process are explained.

### 2-2-1. New Print Process

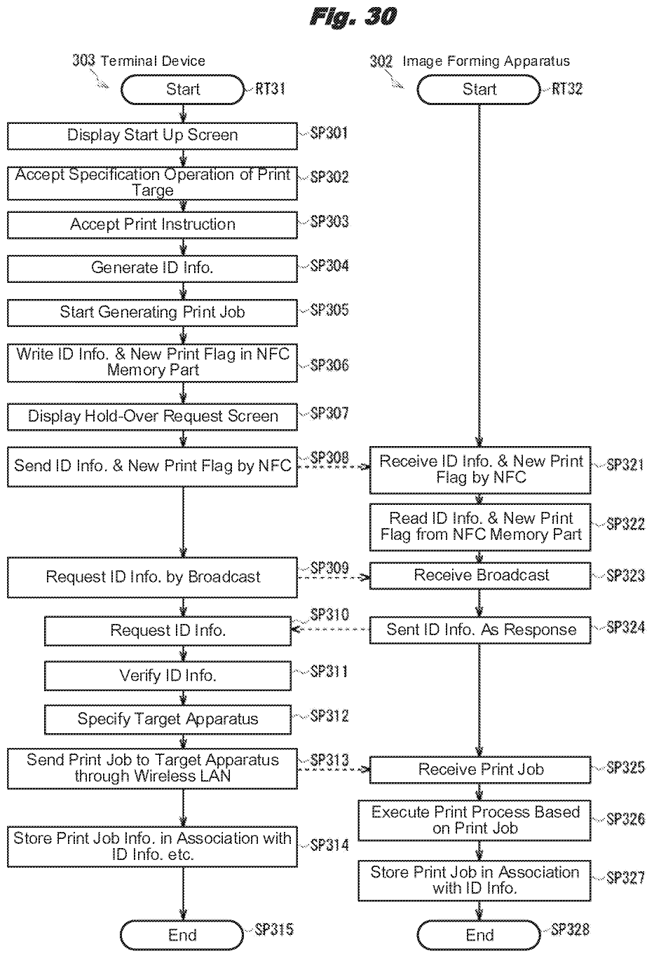

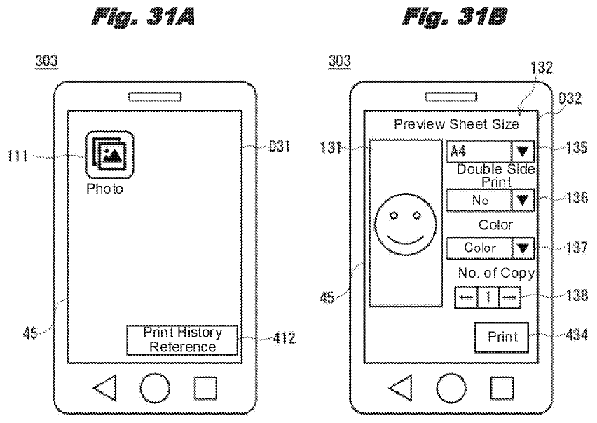

In the image forming system 301, according to a sequence chart shown in FIG. 30, the image forming apparatus 302 and the terminal device 303 collaborate to execute a new print process. Specifically, once a prescribed print application is started by the operation of the user, the control part 341 the terminal device 303 starts a process procedure RT31 in FIG. 30, and moves to SP301.

In SP301 the control part 341 has the display/operation part 45 display a startup screen D31 shown in FIG. 31A, and moves to the next SP302. Although this startup screen D31 has a similar configuration to the startup screen D1 (FIG. 18A) in the first embodiment, a print history reference button 412 is added.

In SP302 the control part 341 has the display/operation part 45 display a photo selection screen D2 (FIG. 18B) etc. as appropriate according to the user's operation (or specification operation to specify a print target) to the startup screen D31, thereby letting the user specify a photo (that is, file) that the user wishes to print, and moves to the next SP303. For the convenience of explanation, hereafter the file of the specified photo is also called the target file.

In response to this, the control part 341 has the display/operation part 45 display a preview screen D32 shown in FIG. 31B. This preview screen D32 has the same preview image 131 and print setting specifying part 132 as on the preview screen D3 in the first embodiment. Also, the preview screen D32 has the print by holding over button 133 omitted from the preview screen D3 and a new print button 434 installed substituting for the print button 134.

In SP303 the control part 341 lets the user specify as appropriate a print setting on the preview screen D32, and once the print button 434 is tapped, it regards that an instruction (or print instruction) has been accepted to print the specified photo (that is, the target file) according to the specified print setting by the image forming apparatus 302, and moves to the next SP304.

In SP304 the control part 341 functions as an identification information generating part (or ID information generating part), generates new unique ID information in association with the target file, and moves to the next SP305. This ID information is, for example, a 128-bit UUID (Universally Unique Identifier) and is a value that does not duplicate other ID information generated in the past by the control part 341 or other ID information generated by other devices etc. In other words, this ID information is information for identifying an association with the terminal device 3.

In SP305 the control part 341 starts generating a print job for printing the target file according to the specified print setting, and moves to the next SP306. In SP306 the control part 341 writes the ID information and a new print flag to an NFC memory part 44M (FIG. 8) of the NFC tag 44, and moves to the next SP307. Among them, the new print flag is data indicating being a new print process.

In SP307 the control part 341 displays a hold-over request screen D7 (FIG. 21A) on the display/operation part 45, thereby requesting the user to hold the display terminal 303 over the NFC tag 14 of the image forming apparatus 302, and moves to the next SP308. In SP308, once the terminal device 303 is held over the NFC tag 14 of the image forming apparatus 302 and communication with the NFC tag 44 through NFC 308 (FIG. 27) is enabled, the control part 341 sends the ID information and the new print flag stored in the NFC memory part 44M through NFC 308, and moves to the next SP309.

On the other hand, the control part 311 of the image forming apparatus 302 has started a process procedure RT32 by executing a prescribed program in advance, and is in a state enabled to receive communication through NFC 308 and the wireless LAN 307.

In the first SP321, once the NFC tag 14 receives the ID information and the new print flag through NFC 308 from the terminal device 303, the control part 311 stores them in the NFC memory part 14M, and moves to the next SP322. In SP322, once the control part 311 reads the ID information and the new print flag from the NFC memory part 14M and stores them in the memory part 312, it moves to the next SP323.

On the other hand, in SP309 the control part 341 of the terminal device 303 requests each terminal device connected to the network of the wireless LAN 307 for ID information by a broadcast, and moves to the next SP310. At this time the broadcast contains the IP address of the terminal device 303 as its origin.

In response to this, once the control part 311 of the image forming apparatus 302 receives the broadcast through the wireless LAN 307 in SP323, it moves to the next SP324. In SP324, as a response to the broadcast, the control part 311 sends the ID information received in SP321 to the terminal device 303 that is the origin of the broadcast. This response contains the IP address assigned to the image forming apparatus 302 as the origin.

Incidentally, in the image forming system 301, when other apparatuses are connected to the wireless LAN 307, responses to the broadcast are sent also from the other apparatuses to the terminal device 303.

In SP310 the control part 341 of the terminal device 303 receives the ID information sent as responses to the broadcast, and moves to the next SP311. At this time, although the terminal device 303 receives responses from the individual apparatuses connected to the wireless LAN 307, in this stage it cannot judge which of them is from the image forming apparatus 302.

In SP311 the control part 341 collates ID information contained in the responses received from the individual apparatuses in SP310 (hereafter called the received ID information) with the ID information generated in SP304 (hereafter called the original ID information), and moves to the next SP312. This process may be referred as a verification process of ID information. In this case, only in one of at least one received response, the received ID information would match with the original ID information.

In SP312 the control part 341 specifies the response whose received ID information matched with the original ID information as the one from the target apparatus, that is, from the image forming apparatus 302 over which the terminal device 303 was held in SP308. Subsequently, the control part 341 stores the IP address contained in the specified response as the origin as the IP address of the image forming apparatus 302, and moves to the next SP313.

In SP313, setting the specified IP address as the destination, the control part 341 sends the print job through the wireless LAN 307 to the destination, that is, the image forming apparatus 302, and moves to the next SP314. In SP314, the control part 341 associates the ID information, the target file, the destination IP address, the print setting, etc. with one another, stores them as print job information in the print history table 350 (FIG. 29) of the memory part 342, and moves to the next SP315, ending a startup-time information write process procedure RT1.

On the other hand, once the print job is sent through the wireless LAN 307 from the terminal device 303, the control part 311 of the image forming apparatus 302 receives it in SP325, and moves to the next SP326. In SP326 the control part 311 converts the print job to prescribed print data as a print process based on the received print job, supplies it to the print part 16 (FIG. 2), thereby having it printed, and moves to the next SP327.

In SP327 the control part 311 associates the ID information received in SP321 and the file name indicating the print job received in SP325 with each other, stores them in the print history table 320 (FIG. 28) of the memory part 312, and afterwards moves to the next SP328, ending the process procedure RT32.

Incidentally, the control part 341 of the terminal device 303 also stores date and time (not shown) when recording the print history to the print history table 350 (FIG. 29) of the memory part 342. Afterwards, once a prescribed period of time such as three days or one week passes since the recorded date and time, the control part 341 deletes the individual print history by an unshown terminal device history deleting part.

Also, the control part 311 of the image forming apparatus 302 also stores date and time (not shown) when recording the print history in the print history table 320 (FIG. 28) of the memory part 312. Afterwards, once a prescribed period of time such as three days or one week passes since the recorded date and time, the control part 311 deletes the individual print history by an unshown image forming apparatus history deleting part.

### 2-2-2. Reprint Process

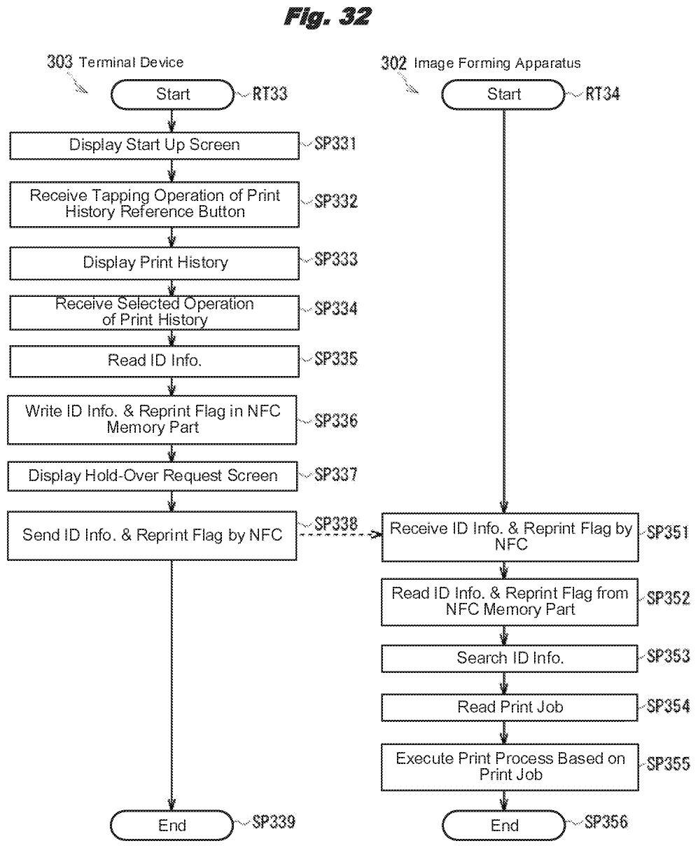

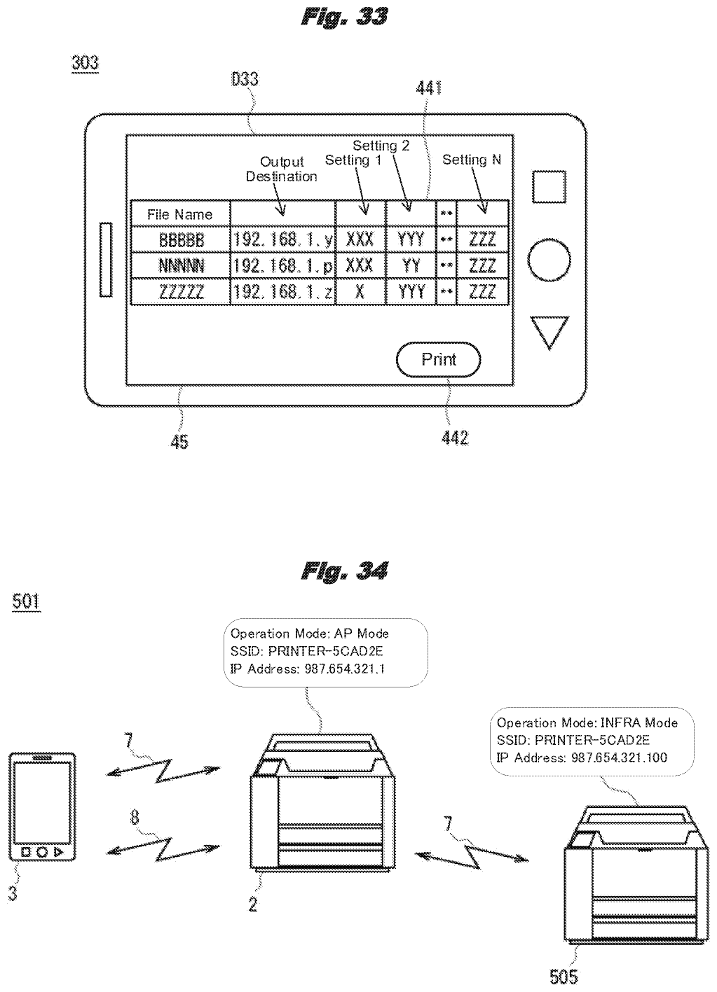

In the image forming system 301, in the same manner as in the new print process, according to a sequence chart shown in FIG. 32, the image forming apparatus 302 and the terminal device 303 collaborate to execute a reprint process. Specifically, once the print application is started by the operation of the user, the control part 341 of the terminal device 303 starts a process procedure RT33 in FIG. 32, and moves to SP331.

In SP331, in the same manner as in SP301 (FIG. 30), the control part 341 has the display/operation part 45 display the startup screen D31 (FIG. 31A), and moves to the next SP332. In SP332, once the print history reference button 412 on the startup screen D31 is tapped by the user, the control part 341 moves to the next SP333. This step may be referred as receiving a tapping operation of the print history reference button.

In SP333 the control part 341 has the display/operation part 45 display a print history display screen D33 shown in FIG. 33, and moves to the next SP334. On this print history display screen D33, a print history table 441 and a print button 442 are displayed. In the print history table 441, among the individual pieces of information stored in the print history table 350 (FIG. 29), the file name, the destination (that is, the IP address of the image forming apparatus 302), the print setting, etc. are displayed in a table format. In this print history table 441, a row can be selected by the user's operation.

In SP334, once the print button 442 is tapped in a state where a row is selected in the print history table 441 on the print history display screen D33, the control part 341 accepts the selected operation as an instruction of reprint process to execute again the selected print history, and moves to the next SP335 (or receive the selected operation of print history). In SP335 the control part 341 reads the ID information of the selected print history from the print history table 350 (FIG. 29) of the memory part 342, and moves to the next SP336.

In SP336 the control part 341 writes the ID information and a reprint flag to the NFC memory part 44M (FIG. 8) of the NFC tag 44, and moves to the next SP337. Among them, the reprint flag is data indicating being a reprint process.

In SP337, in the same manner as in SP307 (FIG. 30), the control part 341 displays the hold-over request screen D7 (FIG. 21A) on the display/operation part 45, thereby requesting the user to hold the terminal device 303 over the NFC tag 14 of the image forming apparatus 302, and moves to the next SP338. In SP338, once the terminal device 303 is held over the NFC tag 14 of the image forming apparatus 302 enabling communication with the NFC tag 44 through NFC 308 (FIG. 27), the control part 341 sends the ID information and the reprint flag stored in the NFC memory part 44M through NFC 308. Afterwards, the control part 341 moves to the next SP339, ending the process procedure RT33.

On the other hand, the control part 311 (FIG. 2) of the image forming apparatus 302 has started a process procedure RT34 by executing a prescribed program in advance, and is in a state enabled to receive communication through NFC 308 and the wireless LAN 307.

In the first SP351, once the NFC tag 14 (FIG. 2) receives the ID information and the reprint flag through NFC 308 from the terminal device 303, the control part 311 stores them in the NFC memory part 14M, and moves to the next SP352. In SP352, once the control part 311 reads the ID information and the reprint flag from the NFC memory part 14M and stores them in the memory part 312, it moves to the next SP353.

In SP353 the control part 311 searches the print history table 320 (FIG. 28) of the memory part 312 for the ID information matching with the ID information received simultaneously with receiving the reprint flag as a trigger (hereafter called the reprint ID information), and moves to the next SP354. In SP354 the control part 311 reads a print job stored in association with the ID information matching with the reprint ID information from the print history table 320 of the memory part 312, and moves to the next SP355.

In SP355 the control part 311 converts the print job into prescribed print data as a print process based on the read print job, supplies it to the print part 16 (FIG. 2), thereby having it printed, and afterwards moves to the next SP356, ending the process procedure RT34.

### 2-3. Efficacy, Etc.

In the above configuration, in the image forming system 301 by the second embodiment, once the terminal device 303 whose ID information has been generated based on the user's operation is held over the image forming apparatus 302, the image forming apparatus 302 is notified through NFC 308 of the ID information. Subsequently, by a broadcast through the wireless LAN 307, the terminal device 303 requests ID information to be sent, recognizes the origin of the response having matching ID information among the received responses as the IP address of the image forming apparatus 302, and sends a print job, having it printed.

That is, in the image forming system 301, without having the user of the terminal device 303 perform a complex work of examining the IP address of the image forming apparatus 302 and further inputting it on the print application, just holding the terminal device 303 over the image forming apparatus 302 allows acquiring the IP address of the image forming apparatus 302 and sending a print job.

At this time, in the image forming system 301, through NFC 308 the image forming apparatus 302 is notified of unique ID information generated in the terminal device 303, and afterwards a broadcast is sent through the wireless LAN 307 to have individual apparatuses send their ID information. Therefore, in the image forming system 301, even if multiple apparatuses are connected to the wireless LAN 307 and the terminal device 303 receives their responses to the broadcast, by collating the ID information, the image forming apparatus 302 over which the user held the terminal device 303, that is, the target apparatus by which the user wishes the print process to be executed, can be securely specified.

Thereby, in the image forming system 301, there is no need to have the terminal device 303 acquire the IP address of the image forming apparatus 302 in advance, and the most recent IP address can be acquired from the image forming apparatus 302 immediately before sending a print job from the terminal device 303. In other words, in the image forming system 301, in the same manner as in the first embodiment, even if the IP address of the image forming apparatus 302 is been changed, the terminal device 303 can automatically acquire the most recent IP address of the image forming apparatus 302 and send the print job.

Also, in the image forming system 301, when performing a new print process, new ID information is generated in the terminal device 303, and the image forming apparatus 302 is notified of this through NFC 308. Therefore, in the image forming system 301, even if a print process was performed in the past by notifying another image forming apparatus connected to the same wireless LAN 307 of other ID information, because their ID information mutually differ, the image forming apparatus 302 can be correctly specified as the target apparatus for this time.

Furthermore, in the image forming system 301, the terminal device 303 stores past ID information along with file names, origins, etc. in the print history table 350 (FIG. 29), and the image forming apparatus 302 stores past ID information in association with print jobs in the print history table 320 (FIG. 28). Thereby, in the image forming system 301, when performing a reprint process to print a once-printed file by the same image forming apparatus 302 again, only the ID information associated with the history selected by the user needs to be sent to the same destination, thereby regeneration or resending of the print job can be omitted.

According to the above configuration, in the image forming system 301 by the second embodiment, the image forming apparatus 302 is notified of the ID information through NFC 308 from the terminal device 303 held over the image forming apparatus 302. By a broadcast through the wireless LAN 307 the terminal device 303 requests the ID information to be sent, specifies the image forming apparatus 302 based on a match of the ID information, and sends a print job, having it printed. Thereby, in the image forming system 301, without having the user of the terminal device 303 perform a complex work related to the wireless LAN, merely holding the terminal device 303 over the image forming apparatus 302 allows acquiring the IP address of the image forming apparatus 302 and sending the print job.

### 3. Other Embodiments

Note that stated in the first embodiment mentioned above was a case where the apparatus that first sent a response to the broadcast was specified as the target apparatus, and stated in the second embodiment was a case where the apparatus that sent matching ID information was specified as the target apparatus. However, this invention is not limited to these, but various other methods can be used to specify one of the responses to the broadcast as the one from the target apparatus. Essentially, the terminal device 3 or the like only needs to acquire the IP address of the image forming apparatus 2 or the like that is the target apparatus based on the origin IP address contained in the responses to the broadcast.

Also, stated in the first embodiment mentioned above was a case where in SP82 and SP83 (FIG. 24) the terminal device 3 receives a response to the broadcast and acquires the origin IP address contained in the response as the IP address of the image forming apparatus 2 that is the target apparatus. However, this invention is not limited to this, but various information such as MAC (Media Access Control) address that can specify the image forming apparatus 2 in the network formed by the wireless LAN 7 can be contained in the response to the broadcast and sent so that the terminal device 3 receiving the response acquires this information. The same also applies to the second embodiment.

Furthermore, stated in the first embodiment mentioned above was a case where the terminal device 3 is held over the image forming apparatus 2 to acquire the SSID and the password of the wireless LAN through NFC 8. However, this invention is not limited to this, but the SSID and the password can be acquired by various methods. For example, the SSID and the password can be displayed on the display/operation part 15 of the image forming apparatus 2, and the user can input these to the terminal device 3. Alternatively, the SSID and the password can be displayed in a two-dimensional code on the display/operation part 15 of the image forming apparatus 2, and the two-dimensional code can be read using a camera (not shown) built in the terminal device 3 to acquire the SSID and the password.

Furthermore, stated in the first embodiment mentioned above was a case where the apparatus that first sent a response to the broadcast from the terminal device 3 was regarded as the target device. However, this invention is not limited to this, but for example, all the devices whose responses to the broadcast were received can be displayed as icons, a list, or the like on the display/operation part 45 of the terminal device 3 to let the user select one of them. Thereby, in a state where as opposed to the image forming apparatus 2 operating in the AP mode, another image forming apparatus 505 operating in the infra mode is connected through the wireless LAN 7 as in the image forming system 501 shown in FIG. 34 that corresponds to FIG. 1 for example, a print process can be executed by letting the user select one of the image forming apparatus 2 and the image forming apparatus 505. That is, in the image forming system 501, by merely holding the terminal device 3 over only one unit of multiple image forming apparatuses, the user can acquire information on all the image forming apparatuses.

Furthermore, stated in the first embodiment mentioned above was a case where the generation of the print job was started in SP42 (FIG. 17) that was earlier than SP58 (FIG. 20) where the terminal device 3 was connected through the wireless LAN 7 to the image forming apparatus 2. However, this invention is not limited to this, but for example the generation of the print job can be started at various timings such as after the terminal device 3 and the image forming apparatus 2 are connected through the wireless LAN 7.

Furthermore, stated in the first embodiment mentioned above was a case where when the registration of the image forming apparatus 2 was instructed after sending a print job from the terminal device 3 to the image forming apparatus 2, the SSID and the password were stored in the apparatus information memory part 72 (FIG. 13) but the IP address was not stored (FIG. 24, SP94). However, this invention is not limited to this, but instead of the SSID and the password, or along with the SSID and the password, the IP address can be stored. In this case, when performing a print process from the terminal device 3 by specifying the registered image forming apparatus 2, if the IP address of the image forming apparatus 2 is changed after the registration, and therefore the connection through the wireless LAN 7 could not be established using the registered IP address, reassignment of an IP address can be performed using the SSID and the password.

Furthermore, stated in the first embodiment mentioned above was a case where if the wireless LAN function was disabled in the image forming apparatus 2, and if the operation mode was not the AP mode (FIG. 20, SP55 and SP57), the notification screens D8 and D9 (FIGS. 21B-21C) were displayed on the display/operation part 45 of the terminal device 3 to notify the user. However, this invention is not limited to this, but for example the messages 181 and 191 on the notification screens D8 and D9 etc. can be displayed on the display/operation part 15 of the image forming apparatus 2 to notify the user. Also, in these cases, a specific operation procedure for the image forming apparatus 2 can be announced in either the terminal device 3 or the image forming apparatus 2.

Furthermore, stated in the second embodiment mentioned above was a case where unique ID information was generated every time when newly performing the print process of a file in the terminal device 303. However, this invention is not limited to this, but information proprietary to the terminal device 303, such as the manufacturer's serial number, can be sent as the ID information. Alternatively, numbers indicating the date and time of the generation can be combined with this manufacturer's serial number to make the ID information. Essentially, when the response to a broadcast is received, the image forming apparatus 302 over which the terminal device 303 was held only needs to be specified as the target apparatus based on the ID information contained in the response.

Furthermore, stated in the second embodiment mentioned above was a case where a print history was recorded in the print history table 350 (FIG. 29) installed in the memory part 342 of the terminal device 303 after executing a print process. However, this invention is not limited to this, but for example the print history table 350 can be omitted from the memory part 342 not to record any print history. The same applies to the print history table 320 of the image forming apparatus 302.

Furthermore, stated in the second embodiment mentioned above was a case where the print history table 320 (FIG. 28) was stored in the memory part 312 (FIG. 2) of the image forming apparatus 302. However, this invention is not limited to this, but for example the print history table 320 can be installed in the memory part of a server or the like (not shown) connected with the image forming apparatus 302 through a prescribed network (not shown) to store the ID information etc. In this case, in addition to the image forming apparatus 302, the ID information etc. in the print history table 320 can be read from another image forming apparatus connected to the network and can be used.

Furthermore, stated in the second embodiment mentioned above was a case where after executing a print process, when a prescribed period of time had passed since recording the print history in the print history table 350 (FIG. 29) of the terminal device 303, the print history was deleted. However, this invention is not limited to this, but for example print history can be recorded in the print history table 350 up to the maximum recordable number of cases, and when the number of recorded cases has reached the maximum number of cases, the oldest one can be deleted and a new print history can be recorded. The same also applies to the print history table 320 (FIG. 28) of the image forming apparatus 302.

Furthermore, stated in the first embodiment was a case where a photo (image data) retained in advance by the terminal device 3 in the memory part 12 was printed by the image forming apparatus 2. However, this invention is not limited to this, but for example, various data such as documents retained in advance by the terminal device 3 in the memory part 12 or various data that can be acquired through an external network such as the Internet can be printed by the image forming apparatus 2. The same also applies to the second embodiment.

Furthermore, stated in the first embodiment was a case where this invention was applied to the image forming system 1 having the terminal device 3 made of a smartphone. However, this invention is not limited to this but can be applied to, for example, an image forming system having a terminal device made of various information processing device such as a tablet terminal or a notebook computer having a wireless LAN and NFC. Essentially, the terminal device only needs to acquire device information through NFC from the image forming apparatus 2. The same also applies to the second embodiment. Furthermore, in the second embodiment, the terminal device and the image forming apparatus 302 can be connected through not only the wireless LAN 307 but also a wired LAN.

Furthermore, stated in the first embodiment was a case where this invention was applied to the image forming system 1 having the image forming apparatus 2 that operates as a copier or a facsimile machine other than a printer. However, this invention is not limited to this but can be applied to an image forming system having an image forming apparatus that operates only as a printer for example. The same also applies to the second embodiment.

Furthermore, this invention is not limited to the above-mentioned individual embodiments or other embodiments. That is, the scope of application of this invention includes embodiments that are arbitrary combinations of part or the whole of the above-mentioned individual embodiments and other embodiments and embodiments that are extractions of part of the embodiments.

Furthermore, stated in the first embodiment mentioned above was a case where the image forming system 1 as an image forming system was configured of the image forming apparatus 2 as an image forming apparatus, the terminal device 3 as a terminal device, and the wireless LAN 7 as a network. Among them, the terminal device was configured of the broadcast inquiry processing part 68 as a broadcast sending part and a response receiving part, the apparatus specifying part 69 as an apparatus specifying part, and the print job sending part 65 as a print job sending part. Also, the image forming apparatus was configured of the broadcast response processing part 27 as a response sending part and the print part 16 as an image forming part. However, this invention is not limited to this, but the image forming system can be configured of an image forming apparatus, a terminal device, and a network having various other configurations. In this case, the terminal device can be configured of a broadcast sending part, a response receiving part, an apparatus specifying part, and a print job sending part having various configurations, and the image forming apparatus can be configured of a response sending part and an image forming part having various configurations.

This invention can be utilized when a print process is executed by sending a print job from a terminal device to an image forming apparatus through a wireless LAN for example.

In the application, to send the broadcast may mean to send a broadcast packet/packets. The broadcast packet/packets are configured to be in accordance with a broadcasting format such that the packet/packets are able to be distributed to one or more of destinations. Such a distribution may be referred as “broadcasting” or “multicasting.” When a packet/packets are sent to a single destination, such a distribution may be referred as “normal communication” or “single casting.” The terminal devices and the image forming apparatus may be configured to perform a communication not only in a broadcasting but in a single casting also.

What is claimed is:

1. An image forming system having an image forming apparatus, a terminal device, and a network that connects the image forming apparatus and the terminal device, wherein
the terminal device is provided with a broadcast packet sending part that sends a broadcast packet, which is associated with a broadcast format, through the network,
the image forming apparatus is provided with
a response sending part that sends, through the network, image forming apparatus specifying information that specifies itself in the network as a response to the broadcast packet, and
an image forming part that forms an image,
the terminal device is further provided with
a response receiving part that receives the response from the image forming apparatus that received the broadcast packet,
an apparatus specifying part that receives the response, and specifies the image forming apparatus that sent the response based on the image forming apparatus specifying information contained in the response wherein the image forming apparatus is a specified image forming apparatus, and
a print job sending part that sends a print job to the specified image forming apparatus through the network based on the image forming apparatus specifying information contained in the response, which is specified by the apparatus specifying part, and
the image forming part of the specified image forming apparatus forms the image on a medium according to the print job received from the terminal device.

2. The image forming system according to claim 1, wherein
the apparatus specifying part—receives the response by the response receiving part such that one image forming apparatus which sent the response is specified.

3. The image forming system according to claim 2, wherein
the network is a wireless local area network, which is defined as wireless LAN,
the image forming apparatus runs in two different operation modes that are an access point mode and another operation mode other than the access point mode, switching therebetween while running,
the image forming apparatus has the operating mode of the wireless LAN set to the access point mode,
the broadcast sending part sends the broadcast packet in a state connected to the image forming apparatus through the wireless LAN, and
the image forming apparatus specifying information is an IP address assigned to the image forming apparatus.

4. The image forming system according to claim 3, further comprising:
an operation part that accepts a print instruction from its user, and
a print job generation part that starts generating the print job according to a print instruction received by the operation part, wherein
the print job sending part connects to the specified image forming apparatus through the wireless LAN after the print job generation is started by the print job generation part.

5. The image forming system according to claim 3, wherein
the terminal device is further provided with a near field communication receiving part that receives a service set identifier, which is referred as an SSID, and a password in the wireless LAN from the specified image forming apparatus through near field communication, and
the broadcast sending part connects to the specified image forming apparatus through the wireless LAN using the SSID and the password received by the near field communication receiving part.

6. The image forming system according to claim 5, wherein
the terminal device is further provided with a memory part that stores the SSID and the password received by the near field communication receiving part, and
when sending the print job for the second time or later to the specified image forming apparatus, the terminal device sends the broadcast packet by the broadcast sending part in a state connected to the specified image forming apparatus through the wireless LAN using the SSID and the password stored in the memory part.

7. The image forming system according to claim 5, wherein
the terminal device is further provided with a display part that displays information,
the near field communication receiving part receives the operation mode of the wireless LAN in the specified image forming apparatus in addition to the SSID and the password, and
when the operation mode of the wireless LAN in the specified image forming apparatus received by the near field communication receiving part is not the access point mode, the display part displays information prompting to switch the operation mode of the wireless LAN in the specified image forming apparatus into the access point mode from the another operation mode.

8. The image forming system according to claim 1, wherein
the terminal device is further provided with a near field communication sending part that sends ID information that can at least identify an association with the terminal device to the specified image forming apparatus through near field communication,
the response sending part of the specified image forming apparatus sends, through the network, the ID information received from the terminal device through the near field communication along with the image forming apparatus specifying information as the response to the broadcast,
the response receiving part receives the response containing the ID information along with the image forming apparatus specifying information, and
the apparatus specifying part receives the response whose ID information matches with the ID information sent by the near field communication sending part, and determines that the response was sent from the specified image forming apparatus.

9. The image forming system according to claim 8, wherein
the terminal device is further provided with an ID information generating part that generates the ID information that uniquely identifies the print job.

10. The image forming system according to claim 9, wherein
the terminal device is further provided with
an operation part that accepts an operation from its user, and
a terminal device history memory part that stores the ID information in association with the print job,
the image forming apparatus is further provided with an image forming apparatus history memory part that stores the print jobs received in the past from the terminal device in association with the ID information,
when reprinting of the print job has been instructed by the user through the operation part, the terminal device reads the ID information associated with the print job from the terminal device history memory part and sends it along with the reprint instruction to the image forming apparatus, and
upon receiving the ID information and the reprint instruction, the image forming apparatus reads the print job associated with the ID information from the image forming apparatus history memory part and forms the image on the medium according to the print job by the image forming part.

11. The image forming system according to claim 10, wherein
the terminal device is further provided with a terminal device history deleting part that deletes the print job and the ID information stored in the terminal device history memory part when a prescribed period of time has passed since they were stored in the terminal device history memory part, and
the image forming apparatus is further provided with an image forming apparatus history deleting part that deletes the print job and the ID information stored in the image forming apparatus history memory part from the image forming apparatus history memory part.

12. The image forming system according to claim 1, wherein
the image forming apparatus is provided with a wireless LAN communication part, which is configured to perform a wireless communication in a single casting such that the image forming apparatus receives the print job either in the single casting or in the broadcasting, forming the image based on the print job.

13. An image forming system having a plurality of image forming apparatuses, a terminal device, and a network that connects the image forming apparatuses and the terminal device, wherein
the terminal device is provided with a broadcast sending part that sends a broadcast through the network,
each of the image forming apparatuses is provided with
a response sending part that sends, through the network, image forming apparatus specifying information that specifies itself in the network as a response to the broadcast, and
an image forming part that forms an image,
the terminal device is further provided with
a response receiving part that receives the responses from the image forming apparatuses that received the broadcast,
an apparatus specifying part that selects one of the responses among the received responses wherein the one of the responses selected is a selected response, and specifies one image forming apparatus that sent the selected response based on the image forming apparatus specifying information contained in the selected response wherein the one image forming apparatus is a specified image forming apparatus, and
a print job sending part that sends a print job to the specified image forming apparatus through the network, which is specified by the apparatus specifying part, and
the image forming part of the specified image forming apparatus forms the image on a medium according to the print job received from the terminal device.

14. The image forming system according to claim 13, wherein
the terminal device is further provided with a near field communication sending part that sends ID information that can at least identify an association with the terminal device to the specified image forming apparatus through near field communication,
the response sending part of the specified image forming apparatus sends, through the network, the ID information received from the terminal device through the near field communication along with the image forming apparatus specifying information as the response to the broadcast,
the response receiving part receives the response containing the ID information along with the image forming apparatus specifying information, and
among the responses received by the response receiving part, the apparatus specifying part select one response whose ID information matches with the ID information sent by the near field communication sending part, and determines that the one response was sent from the specified image forming apparatus.

15. The image forming system according to claim 14, wherein
the terminal device is further provided with
an ID information generating part that generates the ID information that uniquely identifies the print job,
an operation part that accepts an operation from its user, and
a terminal device history memory part that stores the ID information in association with the print job, and
the image forming apparatus is further provided with an image forming apparatus history memory part that stores print jobs received in the past from the terminal device in association with the ID information,
when reprinting of one of the print jobs has been instructed by the user through the operation part, the terminal device reads the ID information associated with the one print job from the terminal device history memory part and sends it along with the reprint instruction to the image forming apparatus, and
upon receiving the ID information and the reprint instruction, the image forming apparatus reads the one print job associated with the ID information from the image forming apparatus history memory part and forms the image on the medium according to the one print job by the image forming part.
